(19) United States
(12) Patent Application Publication
(10) Pub. No.: US 2024/0155375 A1
(43) Pub. Date: May 9, 2024

(54) FEMTOCELLS FOR WIRELESS COMMUNICATION COVERAGE

(71) Applicant: Casa Systems, Inc., Andover, MA (US)

(72) Inventors: Óscar Carrasco Quilis, Valencia (ES); Álvaro del Campo, Torrent (ES); Faiza Bouchmal, Valencia (ES); Pedro Gómez, Valencia (ES); Jordi Calabuig, Valencia (ES)

(73) Assignee: Casa Systems, Inc., Andover, MA (US)

(21) Appl. No.: 18/501,737

(22) Filed: Nov. 3, 2023

Related U.S. Application Data
(60) Provisional application No. 63/422,379, filed on Nov. 3, 2022.

(51) Int. Cl. H04W 16/32; H04W 16/10

(52) U.S. Cl. CPC H04W 16/32; H04W 16/10

(57) ABSTRACT

The techniques described herein relate to femtocells for wireless communication coverage. An example method includes receiving, by a first interface of a virtualized network function (VNF), first wireless data comprising a first identifier identifying a first type of wireless base station in a wireless environment, converting, by the VNF, the first identifier to a second identifier identifying a second type of wireless base station and at least one wireless base station of a plurality of wireless base stations in the environment, the at least one wireless base station being a virtual wireless base station instantiated by the VNF and configured to execute a set of functions to effectuate wireless communication in the environment, and transmitting, by a second interface of the VNF, second wireless data to a network function associated with a wireless core network and comprising the second identifier and at least a portion of the first wireless data.

### RELATED APPLICATION

This patent claims priority under 35 U.S.C. § 119(e) to U.S. Provisional Application No. 63/422,379, titled “5G FEMTOCELLS,” filed on Nov. 3, 2022, which is hereby incorporated by reference herein in its entirety.

### FIELD

The techniques described herein relate generally to wireless networks and, more particularly, to femtocells for wireless communication coverage, including for fifth generation cellular networks.

### BACKGROUND

Successive generations of cellular technologies, such as fifth generation cellular (e.g., 5G), are tasked with supporting an increasing number of connected devices and different types of data requests. The telecommunications industry supports such connected devices and data request types by deploying network base stations (e.g., macro base stations) to provide wireless communication coverage (e.g., radio coverage). Such network base stations may operate and/or serve macrocells configured to effectuate communication between cellular devices, such as cellular phones, and a corresponding core network (e.g., a 5G core network).

### SUMMARY OF THE DISCLOSURE

In accordance with the disclosed subject matter, systems, apparatus, articles of manufacture, and methods are provided for femtocells for wireless communication coverage.

Some embodiments relate to a method for providing wireless communication coverage in a wireless environment. The method comprises receiving, by a first interface of a virtualized network function, first wireless data comprising a first identifier that identifies a first type of wireless base station in the wireless environment; converting, by the virtualized network function, the first identifier to a second identifier, the second identifier identifying a second type of wireless base station and at least one wireless base station of a plurality of wireless base stations in the wireless environment, the second type of wireless base station being different from the first type of wireless base station, the at least one wireless base station being a virtual wireless base station instantiated by the virtualized network function and configured to execute a set of functions to effectuate wireless communication in the wireless environment; and transmitting, by a second interface of the virtualized network function, second wireless data to a network function associated with a wireless core network, the second wireless data comprising the second identifier and at least a portion of the first wireless data.

Some embodiments relate to an apparatus comprising a memory storing instructions, and a processor configured to execute the instructions to perform at least the aforementioned method.

Some embodiments relate to at least one non-transitory computer-readable storage medium comprising instructions that, when executed, cause a processor to perform at least the aforementioned method.

Some embodiments relate to a system comprising a core cloud, at least one user equipment, and an edge cloud server, the edge cloud server comprising a memory storing instructions, and a processor configured to execute the instructions to perform at least the aforementioned method.

Some embodiments relate to a low power fifth generation base station, wherein the base station is a femtocell or Home Next Generation Node B (HgNB). The base station comprising: a set of wireless radio units, each wireless radio unit comprising at least one antenna for wirelessly communicating with user equipment; a communication interface for communicating with a virtualized network interface of a fifth generation cellular network; and a processor in communication with the set of wireless radio units and the communication interface, wherein the processor is configured to use the communication interface to communicate wireless data between the user equipment and the virtualized network interface of the fifth generation cellular network.

The foregoing summary is not intended to be limiting. Moreover, various aspects of the present disclosure may be implemented alone or in combination with other aspects.

### BRIEF DESCRIPTION OF FIGURES

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 is an illustration of an example wireless environment including an example gateway implemented by a mobile network edge cloud to effectuate communication between femtocells and a core network, according to some embodiments.

FIG. 2 is an illustration of another example wireless environment including the gateway of FIG. 1, according to some embodiments.

FIG. 3 is an illustration of yet another example wireless environment including the gateway of FIG. 1, according to some embodiments.

FIG. 4 is an illustration of another example wireless environment including the gateway of FIG. 1 implementing a plurality of example virtual nodes, according to some embodiments.

FIG. 5 is an illustration of example implementations of the mobile network edge cloud and the core network of FIG. 1, according to some embodiments.

FIG. 6 is an illustration of a plurality of femtocell configurations, according to some embodiments.

FIG. 7 is an illustration of an example implementation of a new radio cell global identity, according to some embodiments.

FIGS. 8A and 8B are illustrations of an example workflow to configure the example gateway of FIG. 1, according to some embodiments.

FIG. 8C is an illustration of another example workflow to configure the example gateway of FIG. 1, according to some embodiments.

FIG. 9 is an illustration of an example workflow to register user equipment with an access and mobility management function, according to some embodiments.

FIG. 10 is an illustration of an example workflow to identify user equipment in the wireless environment of FIG. 1, according to some embodiments.

FIGS. 11A and 11B are illustrations of an example workflow to authenticate user equipment in the wireless environment of FIG. 1, according to some embodiments.

FIGS. 12A and 12B are illustrations of an example workflow to perform a handover of user equipment to a different access and mobility management function, according to some embodiments.

FIGS. 13A and 13B are illustrations of an example workflow to facilitate a user equipment service request, according to some embodiments.

FIG. 14 is an illustration of an example workflow to implement a paging procedure, according to some embodiments.

FIGS. 15A and 15B are illustrations of an example workflow to perform an indirect handover procedure, according to some embodiments.

FIGS. 16A and 16B are illustrations of an example workflow to implement an inter-logical handover procedure, according to some embodiments.

FIGS. 17A and 17B are illustrations of an example workflow to perform a direct handover procedure, according to some embodiments.

FIG. 18 is a flowchart representative of an example process that may be performed and/or example machine-readable instructions that may be executed by processor circuitry to implement the gateway of FIG. 1 to effectuate communication between a core network and at least one femtocell, according to some embodiments.

FIG. 19 is another flowchart representative of an example process that may be performed and/or example machine-readable instructions that may be executed by processor circuitry to implement the gateway of FIG. 1 to effectuate communication between a core network and at least one femtocell, according to some embodiments.

FIG. 20 is a flowchart representative of an example process that may be performed and/or example machine-readable instructions that may be executed by processor circuitry to implement a mobile network edge cloud to configure a virtualized network function as a gateway to effectuate communication between a core network and at least one femtocell base station, according to some embodiments.

FIG. 21 is an example electronic platform structured to execute portion(s) of the workflows of FIGS. 8A, 8B, 8C, 9, 10, 11A, 11B, 12A, 12B, 13A, 13B, 14, 15A, 15B, 16A, 16B, 17A, and/or 17B and/or the machine-readable instructions of FIGS. 18, 19, and/or 20 to implement the gateway of FIG. 1, according to some embodiments.

### DETAILED DESCRIPTION

The present application generally provides techniques for femtocells for wireless communication coverage. In telecommunications, a femtocell is a relatively low-range, low-power wireless base station (e.g., cellular base station). Femtocells are typically deployed in, for example, commercial areas (e.g., entertainment venues such as stadiums, offices, transportation centers such as airports, etc.) and/or residential areas (e.g., homes). Femtocells are deployed to provide wireless network coverage (e.g., cellular network coverage) to wireless devices (e.g., cellular devices) where operator base stations (e.g., cellular or mobile network operator base stations) may not reach or have weak signal coverage. Such areas of unavailable service or weak signal coverage may be areas such as inside building complexes, underground structures (e.g., basements, train stations, underground storage facilities, etc.), etc.

Femtocells are typically provided by a mobile network operator and typically connect back through the Internet to provide cellular connectivity. Some femtocells can coordinate with an operator base station to provide mobile devices with improved mobile coverage by switching between femtocells and macrocells according to signal strength. For example, when a macrocell becomes too congested with network traffic, user equipment (e.g., cellular devices) may be offloaded to nearby femtocells to relieve the network traffic congestion.

A macrocell (also referred to as a “macrosite”) is a network cell that can be implemented by a relatively high-range, high-power wireless base station that can send and/or receive radio signals through large towers (referred to as “cell towers” or “cellular towers”) and antennas. For example, a cell tower implementing a macrocell can be relatively tall (e.g., 50 feet, 100 feet, 200 feet, etc.) and provide cellular coverage for miles. Another type of network cell is a small cell, which can be implemented by a cellular base station with a physical footprint smaller than a cell tower and larger than a cellular base station that implements a femtocell. A small cell can send and/or receive radio signals to improve wireless network connectivity in specific areas. A small cell requires less power than a cell tower but has a smaller coverage area (e.g., a range of 300 feet to 8000 feet) than a cell tower.

Telecommunications providers utilize a combination of cells (e.g., macrocells, small cells) to provide wireless coverage in areas to effectuate the transmission and/or reception of wireless data. Wireless data may be implemented as cellular data generated, received, and/or transmitted in accordance with various cellular standards and/or architectures, such as third generation cellular (e.g., 3G), fourth generation long-term evolution cellular (e.g., 4G LTE), fifth generation cellular (e.g., 5G), future sixth generation cellular or next generation cellular, etc., standards and/or architectures. For example, wireless data may be transmitted and/or received by an electronic device associated with an end user (e.g., user equipment (UE)) in a telecommunications network (e.g., sometimes “telecom network” or “Telcom network”). In some examples, the telecom network may be implemented by an architecture based on a standard associated with the 3rd Generation Partnership Project (“3GPP”), the Open Radio Access Network (O-RAN) Alliance (“O-RAN Alliance”), or the like.

As the commercial deployment of next generation communication systems (e.g., 5G or subsequent generation communication systems) grows, several efforts have been made to cope with the exponential increasing traffic demand experienced in next generation communication networks (e.g., 5G or subsequent generation communication networks) that are currently served only by a macrocell layer. However, changes to conventional communication architectures and techniques are needed to increase the communication network density and expand the aggregated capacity while minimizing the deployment complexity and energy consumption of both infrastructure and devices for enabling the full potential of these next generation communication systems.

Conventional approaches to improve next generation communication systems (e.g., 5G communication systems) by extending the network capacity include the use of small cells (e.g., 5G small cells), cloud radio access networks (cloud RANs), and coordinated multi-point transmission and reception (CoMP). However, the inventors have recognized that these approaches are not tailored to a vast majority of deployment applications and scenarios where dedicated backhaul networks are not available. The inventors have recognized that, when dedicated backhaul networks are not available, non-trusted Internet broadband connections are used to deploy the radio access network (RAN) in private homes, businesses or industries, etc. Such non-trusted Internet broadband connections may be used in areas, such as homes and businesses, where short-range base stations operating in high frequency bands with high bandwidth, like millimeter wave (mmWave) bands, are used due to the characteristic attenuation that the radio signal experiences at these frequencies where the mobile terminal requires to be very close to the base station. Additionally, the inventors have recognized that these conventional approaches lack the required deployment simplicity and unplanned scalability that self-organized next generation communication networks can deliver. Beneficially, the inventors have recognized that femtocells as disclosed herein can overcome the challenges of the aforementioned conventional approaches and address operator needs in terms of network capacity and/or coverage extension (e.g., indoor coverage extension).

The technology developed by the inventors enable 5G system support for 5G femtocells to achieve increased network capacity and/or improved coverage extension in 5G networks. 5G femtocells as disclosed herein can be established, instantiated, managed, and/or operated by one or more Home Next Generation Node Bs (HgNBs). In some embodiments, HgNBs can be implemented by one or more wireless base stations to provide and/or extend wireless coverage to specific areas, such as indoor environments. In some embodiments, an HgNB can be either a single cell 5G base station device or a multi-cell 5G base station device with up to 8 cells based on the selected HgNB identifier (ID) length. In some embodiments, HgNBs can enable dual-mode 5G New Radio (NR) femtocells integrating multiple sub-6 Gigahertz (GHz) radios (e.g., FR1 radios) and mmWave radios (e.g., FR2 radios) to implement a multi-carrier multi-cell solution.

In some embodiments, the technology developed by the inventors include a virtualized network function (also referred to as a “virtual network function”) referred to as a HgNB gateway (HgNB-GW) to effectuate communication between HgNBs and a 5G core network (or simply the “5G core”). In some embodiments, the HgNB-GW is implemented by hardware alone, or a combination of hardware, software, and/or firmware that can interact with various 5G network elements such as the access and mobility management function (AMF), macro gNBs (e.g., gNBs implemented by macrocells), and HgNBs. In some embodiments, the HgNB-GW can be configured to effectuate network procedures such as the NG setup procedure, initial UE messages procedure, and/or various N2 and Xn interface handover procedures.

In some embodiments, the HgNB-GW can implement one or more virtualized network functions to support a wide variety of functions (e.g., network functions), which can include next-generation application protocol (NGAP) message relaying, AMF routing, and HgNB discovery. In some embodiments, the HgNB-GW can enable interoperability between HgNBs and the 5G core by translating an HgNB identifier (ID) with a first length (e.g., a data length in a range of 33-bits to 36-bits) into a gNB ID with a second length (e.g., a data length in a range of 22-bits to 32-bits) different than the first length. Beneficially, through at least the translation of the HgNB and the gNB IDs, the HgNB-GW can establish an aggregation layer to support a scalable 5G network architecture. Such an aggregation layer can enable network operators to efficiently manage and/or aggregate a substantial number of HgNBs (e.g., 5000 HgNBs, 10,000 HgNBs, 16,384 gNBs) and/or corresponding 5G femtocells through one or more single virtualized logical gNB instances over one or more NGAP interfaces. In some embodiments, the aggregation level implemented in the HgNB-GW depends on the ID lengths configured for gNBs and HgNBs as the ID transformation provides the number of N2 interfaces that are aggregated in a virtualized logical gNB on the HgNB-GW towards the AMF in a single N2 interface. For example, when the HgNB ID length is set to 36-bits with up to one cell per HgNB and the gNB ID length is set to 22-bits, the aggregation factor becomes 2⁽³⁶⁻²²⁾=2¹⁴=16,384.

In some embodiments, the technology developed by the inventors includes specifications of new information elements. These new information elements can be used in control signaling for identifying 5G femtocells using a HgNB ID with different lengths than the gNB ID. The different lengths of HgNB and gNB IDs can be used to enable advanced self-organization algorithms to self-configure the RAN for mobility and load management as well as for enabling the HgNB-GW to implement efficient control messaging routing procedures.

In some embodiments, several procedures and call flows are described in which an HgNB is using an HgNB ID of 33-bits and a gNB ID of 22-bits. These procedures can include the setup of a new virtualized logical gNB instance, which can occur when an HgNB sets up an NGAP interface with the HgNB-GW using an HgNB ID with the gNB ID length number of most significative bits (MSBs), in this case 22-bits, corresponding to a non-used gNB ID. In such a procedure, a new virtualized logical gNB instance can be created in the HgNB-GW and this instance can perform an NGAP setup procedure using the gNB ID length configured for this network, in this case 22-bits. Subsequent HgNBs associated with the same virtualized logical gNB ID, using an HgNB ID with the same 22 MSBs but the other 11 least significative bits (LSBs) that perform an NGAP Setup with the HgNB-GW through the HgNB interface can trigger a RAN configuration update procedure and, thus, adding seamlessly into the network the configuration data of the newly deployed 5G femtocells. Throughout such procedures (and others), the HgNB-GW can efficiently and transparently forward signaling information received from the different HgNBs to aggregate the signaling of multiple HgNBs in a single NGAP interface. Beneficially, the technology developed by the inventors simplifies network management and enhances overall network operation by minimizing and/or otherwise reducing the number of Stream Control Transmission Protocol (SCTP) associations and NGAP interfaces between the RAN and the 5G core.

In some embodiments a description of the XnAP Proxy function is provided to facilitate for the operator an aggregation layer for Xn Interfaces to deploy a single Xn integration point between the macrocell layer and the femtocell layer to enable 5G Advanced features like New Radio-New Radio dual connectivity (NR-DC) and multiple transmission reception point (Multi-TRP) features. In some embodiments, for deploying 5G femtocells using untrusted backhaul networks, example evolved 5G network architectures disclosed herein can implement a set of security gateway instances to secure the communications between the 5G femtocell and the 5G core for guaranteeing confidentiality and integrity of user data and signaling interfaces of HgNBs.

Beneficially, the HgNB-GW and/or, more generally, the technology developed by the inventors disclosed herein, can achieve smooth operation of 5G networks by contributing to their efficiency, reliability, and scalability. As 5G networks continue to evolve and accommodate a growing number of HgNBs and connected devices, the HgNB-GW can enable the network to meet the demands of subsequent next generation communication networks while ensuring high availability and seamless communication between HgNBs and the 5G core.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

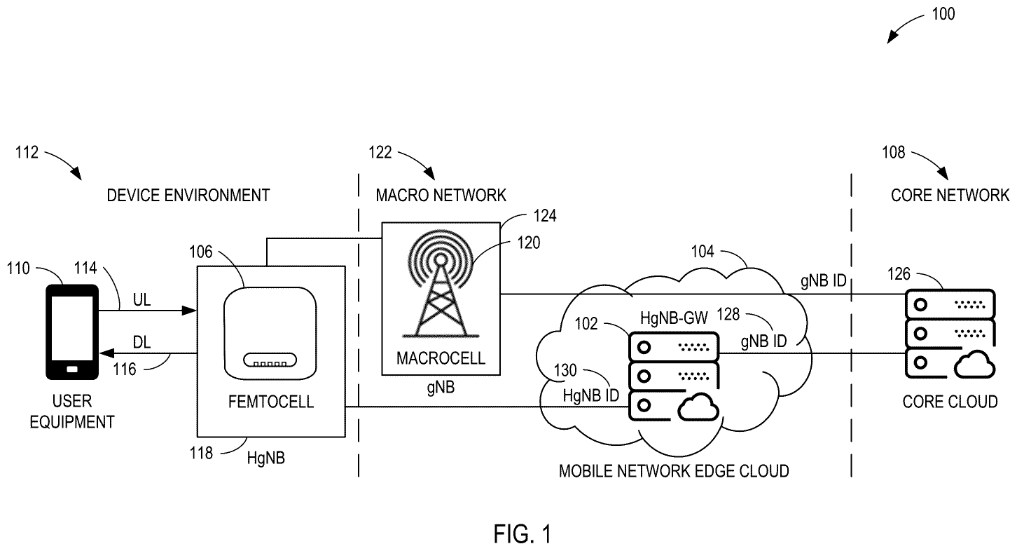

Turning to the figures, the illustrated example of FIG. 1 is an illustration of an example wireless environment 100 including an example gateway 102 implemented by a mobile network edge cloud 104 to effectuate communication between at least one femtocell 106 and a core network 108. The wireless environment 100 of this example is a cellular network, such as a 5G network system based on a 3rd Generation Partnership Project (3GPP) architecture. Although illustrated with reference to 5G network systems, it should be appreciated that other network configurations and/or architectures are also possible. For example, the techniques described herein could also be applied to other network systems such as 4G LTE network systems or future generation (e.g., 6G) network systems, as the techniques described herein are not limited in this respect. Although illustrated with reference to 3GPP architectures, other network architectures are also possible. For example, techniques described herein could also be applied to other architectures such as an Open Radio Access Network (O-RAN) architecture or a Small Cell Forum (SCF) architecture. Additionally or alternatively, the wireless environment 100 may be any other type of wireless network, such as a Wireless Fidelity (Wi-Fi) network or a satellite-based wireless network. Any other type of wireless network is contemplated.

The wireless environment 100 of the illustrated example can effectuate communication between user equipment (UE) 110 in a device environment 112 and the core network 108. Non-limiting examples of the device environment 112 include a residential environment (e.g., a home, a neighborhood, a multi-unit complex such as an apartment or condominium building) and a commercial environment (e.g., an airport terminal, an education building such as a school or university, a hospital, an office building, a warehouse, etc.). Any other type of environment is contemplated.

The device environment 112 of the illustrated example can include a plurality of devices, such as ones of the shown UE 110. Although only a single UE 110 is shown, the device environment 112 can include a plurality of UE (e.g., 5 UE, 10 UE, 100 UE, 1000 UE, etc.). The UE 110 of this example is a handheld device, such as an Internet-enabled smartphone. Additionally or alternatively, the UE 110 may be any type of electronic device such as a desktop computer, a laptop computer, a tablet computer, autonomous equipment (e.g., an autonomous vehicle, autonomous industrial equipment, a drone, etc.), an Internet-of-Things (IoT) device, a server (e.g., a computer server, a blade server, a rack-mounted server, etc.), a wearable device (e.g., an augmented reality and/or virtual reality (AR/VR) device, a heads-up display (HUD) device, a fitness tracker, a smartwatch, smart glasses, smart goggles, a medical device patch, a medical bracelet, etc.), a workstation, or any other type of computing and/or electronic device.

The UE 110 can be in communication with the femtocell 106 via one or more communication links 114, 116. The communication links 114, 116 are wireless connections to effectuate transmission of uplink (UL) data from the UE 110 to the femtocell 106 using UL communication links 114 and/or reception of downlink (DL) data at the UE 110 from the femtocell 106 using DL communication links 116. For example, the wireless connections can be 4G LTE wireless connections, 5G wireless connections, future generation (e.g., 6G) wireless connections, or the like. In some embodiments, the wireless connections can be implemented by a 5G 3GPP protocol, a future generation 3GPP protocol, etc. In some examples, the wireless connections can be compatible across generations of 3GPP protocols. For example, the femtocell 106 can communicate with one or more first UE using a 4G 3GPP protocol and with one or more second UE using a 5G 3GPP protocol. Additionally or alternatively, the communication links 114, 116 may be any other type of wireless connections such as satellite connections (e.g., beyond-line-of-site (BLOS) satellite connections, line-of-site (LOS) satellite connections, etc.), Ultra Wideband (UWB) connections, etc., and/or any combination(s) thereof.

The device environment 112 of the illustrated example can include a plurality of femtocells, such as ones of the shown femtocell 106. Although only a single femtocell 106 is shown, the device environment 112 can include a plurality of femtocells (e.g., 5 femtocells, 10 femtocells, 100 femtocells, 1000 femtocells, etc.). The femtocell 106 of this example is a wireless base station (e.g., a cellular base station, a 5G cellular base station). The femtocell 106 of this example is a 5G femtocell. Any other type of femtocell is contemplated such as a 3G, 4G LTE, or future generation (e.g., 6G) femtocell. The femtocell 106 of this example is configured to be and/or operate as a home Next Generation Node B (HgNB) 118. In some embodiments, the HgNB 118 is a 3GPP-compliant implementation of the fifth generation new radio (5G NR) base station configured to execute one or more cellular network functions to provide connectivity between the UE 110 and the core network 108. For example, the HgNB 118 can implement ones of the functions specified in the 3GPP standards for the gNB function, enforcing all features, clauses, and conditions specified for the different protocol stack layers, interfaces, and standard procedures. In some such embodiments, the HgNB 118 can include additional signaling enhancements and/or procedures to enable the differentiation of 5G femtocells (e.g., HgNBs) from macrocells and/or small cells (e.g., gNBs) such that the UE 110 can establish 5G NR communication with the femtocell 106.

In the illustrated example, the femtocell 106 is communicatively coupled to at least one of a macrocell 120 in a macro network 122 or the gateway 102 in the mobile network edge cloud 104. The macro network 122 of the illustrated example can include a plurality of macrocells, such as ones of the shown macrocell 120. Although only a single macrocell 120 is shown, the macro network 122 can include a plurality of macrocells (e.g., 5 macrocells, 10 macrocells, 100 macrocells, 1000 macrocells, etc.). The macrocell 120 of this example is and/or implemented by a remote radio unit (RRU). The macrocell 120 of this example is a 5G macrocell. Any other type of macrocell is contemplated such as a 3G, 4G LTE, or future generation (e.g., 6G) macrocell. The macrocell 120 of this example is configured to be and/or operate as a Next Generation Node B (gNB) 124. In some embodiments, the gNB 124 is a 3GPP-compliant implementation of the 5G NR base station configured to execute one or more cellular network functions to provide connectivity between the femtocell 106 and the core network 108. For example, the gNB 124 can implement ones of the functions specified in the 3GPP standards for the gNB function, enforcing all features, clauses, and conditions specified for the different protocol stack layers, interfaces, and standard procedures.

The macrocell 120 and/or, more generally, the macro network 122, is communicatively coupled to a core cloud 126 of the core network 108. The core network 108 of this example is the 5G core (e.g., the 5G core network). The core cloud 126 of this example is a 5G core cloud. In some embodiments, the core cloud 126 can be implemented by one or more logical nodes that host data and control plane operations. In some embodiments, the core cloud 126 can facilitate communication between the mobile network edge cloud 104 and a cloud network. For example, the cloud network may be network(s) hosted by a public cloud provider, a private cloud provider, a telecommunications operator, etc. In some embodiments, the core cloud 126 can be implemented by one or more physical hardware servers, virtualizations of the one or more physical hardware servers, virtualized network functions (VNFs), etc., and/or any combination(s) thereof. For example, the core cloud 126 can be implemented by hardware alone, or a combination of hardware, software, and/or firmware. Although only a single core cloud 126 is depicted, the core network 108 can be implemented by any number of core clouds.

In the illustrated example, the gateway 102 effectuates communication between the femtocell 106 and the core cloud 126 and/or, more generally, the core network 108. The gateway 102 of this example can be implemented by one or more virtualized network functions (VNFs) that, when instantiated and/or executed, implement an HgNB gateway (HgNB-GW). For example, the gateway 102 can be configured to be (i) represented to the core cloud 126 as a node, such as a gNB, and (ii) represented to the femtocell 106 as one or more network functions hosted by the core cloud 126. Non-limiting examples of the network functions hosted by the core cloud 126 include the access and mobility management function (AMF) and the session management function (SMF). Any other type of network function is contemplated to be hosted by the core cloud 126 such as authentication and authorization and/or subscriber data management and policy management. In some embodiments, the node instantiated by the gateway 102 can execute a set of functions to effectuate wireless communication in the wireless environment 100.

In example operation, the gateway 102 can receive first wireless data including a first identifier 128 (identified by gNB ID) that identifies a first type of wireless base station, such as a base station operating and/or serving a macrocell or a small cell (e.g., a macro base station), in the wireless environment 100. Additionally or alternatively, the gNB ID 128 can identify a node instantiated by the gateway 102, such as a gNB.

In example operation, the gateway 102 can convert and/or translate the gNB ID 128 to a second identifier 130 (identified by HgNB ID) that identifies a second type of wireless base station, such as base station (e.g., a femtocell base station) operating and/or serving the femtocell 106. Additionally or alternatively, the HgNB ID 130 can identify at least one base station (e.g., a base station that implements the shown femtocell 106) of a plurality of base stations in the wireless environment 100.

In example operation, the gateway 102 can transmit and/or cause transmission of second wireless data to the at least one base station (e.g., at least the base station that implements the shown femtocell 106) associated with the second type of wireless base station (e.g., the femtocell 106). In some embodiments, the second wireless data includes the HgNB ID 130 and at least a portion of the first wireless data.

In example operation, the gateway 102 can receive third wireless data from the at least one base station (e.g., at least the base station that implements the femtocell 106). In some embodiments, the third wireless data includes the HgNB ID 130.

In example operation, the gateway 102 converts and/or translates the HgNB ID 130 to the gNB ID 128. In example operation, the gateway 102 transmits and/or causes transmission of fourth wireless data to the core cloud 126 and/or, more generally, the core network 108. In some embodiments, the fourth wireless data includes the gNB ID 128 and at least a portion of the third wireless data.

In some embodiments, the first, second, third, and/or fourth wireless data can be implemented as cellular data generated, received, and/or transmitted in accordance with various cellular standards and/or architectures, such as third generation cellular (e.g., 3G), fourth generation long-term evolution cellular (e.g., 4G LTE), fifth generation cellular (e.g., 5G), future sixth generation cellular or next generation cellular, etc., standards and/or architectures as described herein. For example, the first and/or second wireless data can be data requested by the UE 110. Non-limiting examples of data requested by the UE 110 can be audio data (e.g., music), image data (e.g., a picture), text data, video data (e.g., a movie, a short-duration video, a chapter or episode of a television show, etc.), a webpage, etc., and/or any combination(s) thereof. In some embodiments, the third and/or fourth wireless data can be requests for data by the UE 110. For example, the third and/or fourth wireless data can be requests for audio data, image data, text data, video data, a webpage, etc., and/or any combination(s) thereof.

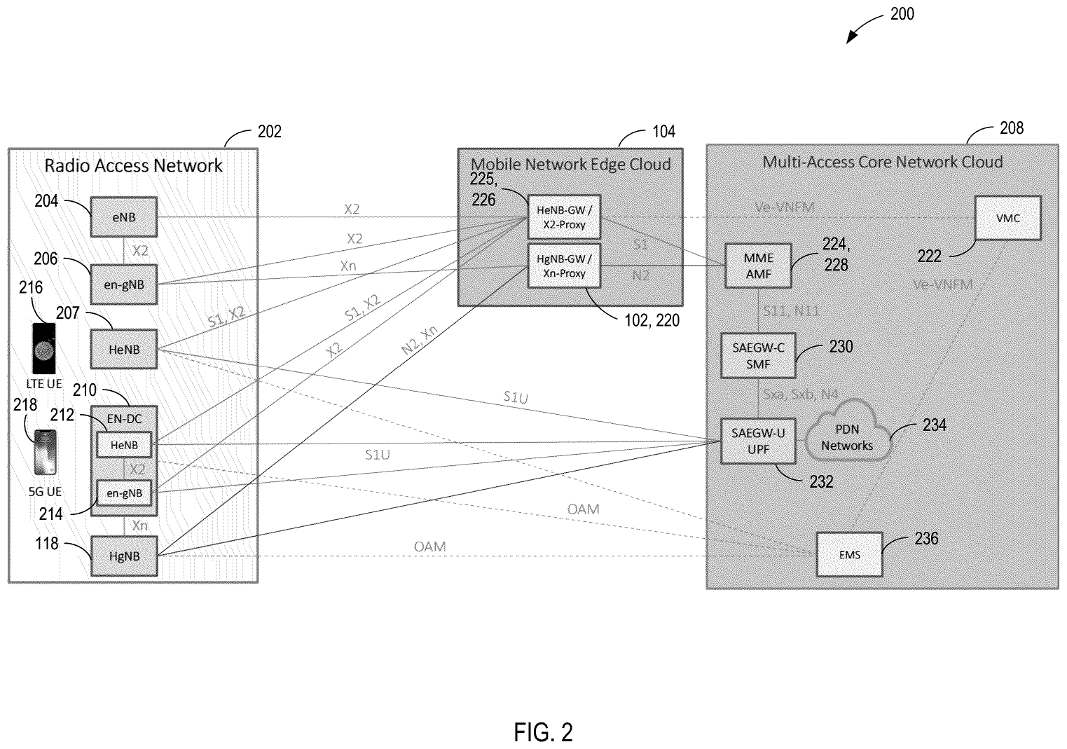

FIG. 2 is an illustration of another example wireless environment 200 including the gateway 102 of FIG. 1. In some embodiments, the wireless environment 200 can correspond to and/or implement the wireless environment 100 of FIG. 1. The wireless environment 200 of this example illustrates the 5G network evolution when 5G femtocells (e.g., HgNBs such as the HgNB 118 of FIG. 1) are co-deployed with 4G femtocells, 4G eNBs, 5G gNBs, and Dual Mode Non-Standalone 5G femtocells for enabling 4G, 5G Non-Standalone (5G NSA) and 5G Standalone (SA) services ushering in a new paradigm in mobile network architectures using a multi-access core network 208 that supports concurrently 4G and 5G radio access networks. In some embodiments, the multi-access core network 208 can implement the core cloud 126 of FIG. 1 and/or, more generally, the core network 108 of FIG. 1.

The wireless environment 200 of the illustrated example includes a radio access network 202 that supports concurrently 4G and 5G radio access network technologies operating in several modes including 4G LTE only, 5G Non-Standalone (NSA) using Evolved Universal Terrestrial Radio Access Network and New Radio Dual Connectivity (EN-DC) access, 5G Standalone (SA) access, and New Radio Dual Connectivity (NR-DC) 5G Standalone access. For example, the radio access network 202 includes and/or implements a 4G macro eNB network including an eNB 204, a 5G gNB macro network including an en-gNB 206, a 4G femtocell network including an HeNB 207, an enterprise dual mode small cell network including a dual mode non-standalone 5G small cell 210 (identified by EN-DC) composed by an 4G HeNB 212 and a 5G NSA en-gNB 214 that are connected through an internal logical X2 interface, and a 5G femtocell network including an HgNB 118.

The eNB 204 and the en-gNB 206 are connected one to each other via an X2 interface performing concurrently 4G LTE, 5G NSA, and 5G SA access. The eNB 204 is connected via an X2 interface with an X2-Proxy function 226 to implement 4G mobility and SON procedures with 4G HeNBs 207, 212 and performing EN-DC 5G NSA access with the en-gNB 214 and the HgNB 118 of FIG. 1. The en-gNB 206 and the en-gNB 214 are connected via an X2 interface with the X2-Proxy function 226 performing EN-DC 5G NSA access as Secondary gNB with the HeNB 207 and the HeNB 212 and is connected via an Xn interface with the Xn-Proxy 220 performing NR-DC 5G SA access with the HgNB 118 of FIG. 1 performing either Primary gNB and Secondary gNB functions. The HeNB 207 is performing 4G only access and is connected via an X2 interface to the X2-Proxy function 226 to implement SON procedures with eNB 204 and HeNB 212 and performing EN-DC 5G NSA access with the en-gNB 206 and the en-gNB 214 acting as a Master eNB. In the dual mode non-standalone 5G small cell 210, the HeNB 212 is connected to the co-located en-gNB 214 via a logical X2 interface performing EN-DC 5G NSA access. The dual mode non-standalone 5G small cell 210 is connected to the X2-Proxy function 226 to implement SON procedures with eNB 204 and HeNB 207 and perform EN-DC 5G NSA access with the en-gNB 206 acting as a Master eNB. The en-gNB 214 is connected via an X2 interface with the X2-Proxy function 226 performing EN-DC 5G NSA access as Secondary gNB with the eNB 204 and the HeNB 207 terminating the user-plane at the SAEGW-U/UPF. The HgNB 118 of FIG. 1 is connected to the gateway 102 performing 5G SA access 212 and is connected via an Xn interface with an Xn-Proxy 220 performing NR-DC 5G SA access with the en-gNB 206 performing either Primary gNB or Secondary gNB functions. Further depicted are example UE 216, 218 such as an LTE UE 216 and a 5G UE 218. In the shown example, the UE 216 are cellular phones but any other type of LTE and/or 5G UE is contemplated.

With the introduction of 5G SA femtocells, the aggregation layer deployed in the mobile network edge cloud 104 of FIG. 1 includes the HgNB-GW 102 of FIG. 1, which may include Xn Proxy functions 220 (identified by Xn-Proxy) deployed as virtual network functions controlled by the Orchestrator or Virtual Machine Controller (VMC) 222 that provide N2 interfaces to the HgNB portion of the radio access network 202 and the AMF 224 of the multi-access core network cloud 208 and Xn interfaces to the HgNB radio access network and the macro gNB portion of the radio access network 202, respectively.

In some embodiments, in order to provide backwards compatibility with 4G supporting 5G NSA, the mobile network edge cloud 104 can include an HeNB-GW 225 and X2 Proxy functions 226 (identified by X2-Proxy) deployed as virtual network functions controlled by the VMC 222 that provide S1AP interfaces to the to the HeNB portion of the radio access network 202 and the mobility management entity (MME) 228 of the multi-access core network cloud 208 and X2 interfaces to the HeNB radio access network, the macro eNB access network, the HgNB radio access network acting as en-HgNBs for EN-DC and the macro gNB access network acting as en-gNBs for EN-DC respectively. The multi-access core network cloud 208 includes and/or implements other network functions such as a system architecture evolution gateway session management function (SAEGW-C SMF) 230, a system architecture evolution gateway user plane function (SAEGW-U UPF) 232, and packet data networks (PDN) 234.

In the illustrated example, the standalone HgNB 118 can establish an N2 interface with the HgNB-GW 102, a Xn interface towards the Xn-Proxy 220, other HgNBs, EN-DC small cells or other macro gNBs, and an Operation and Maintenance (OAM) interface towards an Element Management System (EMS) 236. In some embodiments, the Xn-Proxy 220 exposes a TNL address or the Xn interface to the macro layer. In some embodiments, the Xn-Proxy 220 implements a single Xn interface per logical gNB towards the different macrocells of the network. In some embodiments, the Xn-Proxy 220 translates HgNB identities (also referred to as HgNB identifiers or HgNB IDs) into gNodeB identities (also referred to as gNB identifiers or gNB IDs) to minimize the number of Xn associations by exposing HgNBs as served cells of a macro gNB implemented by the virtualized logical gNB instance. In some such embodiments, this function isolates the Xn interface of the 5G femtocell layer implementing independent Xn identifiers to avoid mismatches between the 5G femtocell layer and the individual identifiers assigned by the HgNBs and the identifiers assigned between the Xn Proxy 220 and the macro layer.

In some embodiments, the 5G femtocell (e.g., the HgNB 118) implements all the functions specified in 3GPP standards for the gNB function, enforcing all features, clauses and conditions specified for the different protocol stack layers, interfaces and standard procedures but adding the specific signaling enhancements and additional procedures that allows differentiating 5G femtocells from standard gNBs described herein to allow 5G UEs, such as the 5G UE 218, to establish 5G NR communication link with a corresponding base station.

The illustrated example describes the introduction of the 5G network evolution with 5G femtocells for enabling the deployment of heterogeneous ultra-dense 5G advanced networks streamlining the deployment of cost-effective 5G NR indoor small cells including the HgNB-GW 102 for signaling optimization with the 5G core functions deployed in the multi-access core network cloud 208. In some embodiments, the signaling optimization can be performed such that inbound and outbound mobility for cells served by the HgNB-GW 102 are effectively managed and provide an inter-layer EN-DC and NR-DC integration point in the X2 Proxy 226 and Xn Proxy 220 functions. Beneficially, such signaling optimization can achieve increased network capacity of the wireless environment 200 with faster data speeds, lower latencies and the capacity to accommodate a vastly increased number of connected devices such as the UE 216, 218.

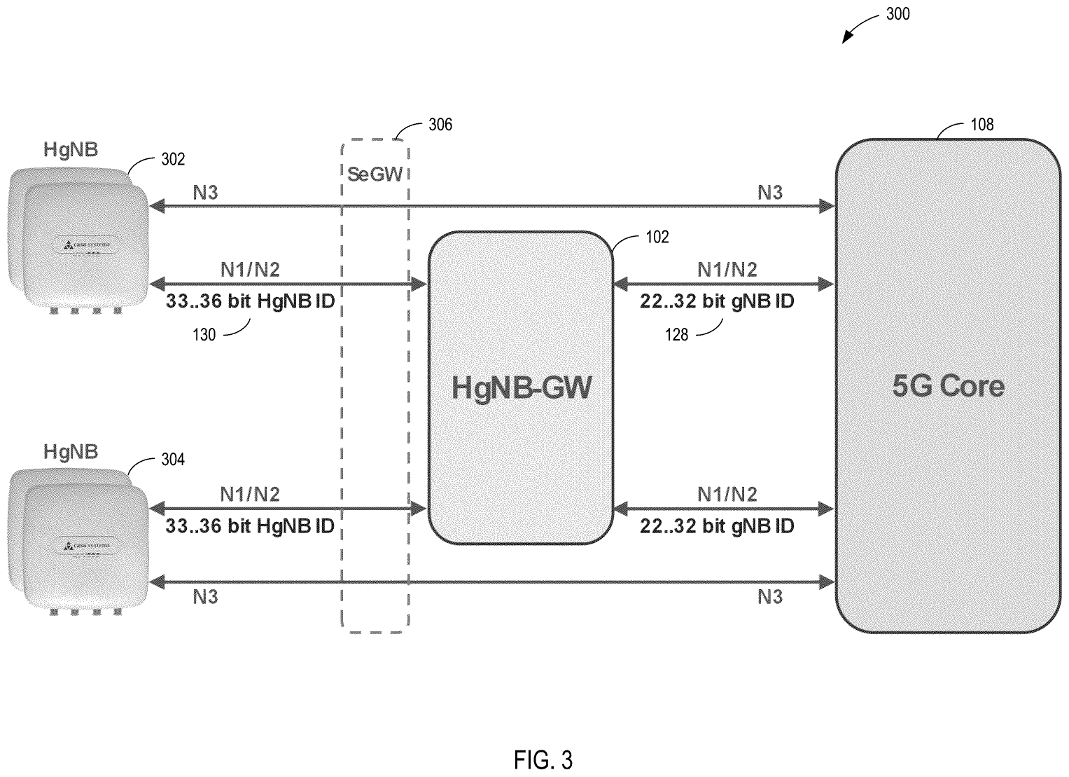

FIG. 3 is an illustration of yet another example wireless environment 300 including the gateway 102 and the core network 108 of FIG. 1. In some embodiments, the wireless environment 300 can correspond to and/or implement the wireless environment 100 of FIG. 1 and/or the wireless environment 200 of FIG. 2. The wireless environment 300 of this example includes a first plurality of base stations 302 and a second plurality of base stations 304. In some embodiments, each of the first plurality of base stations 302 can implement a respective HgNB, such as the HgNB 118 of FIGS. 1 and/or 2. In some embodiments, each of the second plurality of base stations 304 can implement a respective HgNB, such as the HgNB 118 of FIGS. 1 and/or 2.

In the illustrated example, the wireless environment 300 is implemented by a logical architecture of evolved 5G Advanced SA Femtocell Network in which the HgNB uses the HgNB ID 130 in the N2 interface established with the gateway 102. In this example, the HgNB ID 130 is implemented by a bitstring with a length in a range of 33-bits to 36-bits. Any other bitstring length and/or range is contemplated. In this example, the gNB ID 128 is implemented by a bitstring with a length in a range of 22-bits to 32-bits. Any other bitstring length and/or range is contemplated. In some embodiments, the bitstring of the gNB ID 128 matches the MSBs of the HgNB ID 130 for the length of the gNB ID 128 to enable an HgNB to serve multiple NR Cells. For example, if the gNB ID 128 is implemented by a bitstring with a length of 22-bits, the gNB ID 128 bitstring can match the 22 MSBs of the HgNB ID 130. In some such embodiments, all HgNBs connecting to the gateway 102 have the same length of the HgNB ID 130 to avoid ambiguities of target HgNB selection.

In some embodiments, the gateway 102 interaction with the AMF of the core network 108 can enable deploying multiple logical gNBs instances of the gateway 102 to share the same Internet Protocol (IP) address with different Stream Control Transmission Protocol (SCTP) ports. In some such embodiments, the AMF can route handover messages and/or RAN configuration transfer messages to the gateway 102 based on the 22-bit target gNB ID 128 contained in these messages. In some such embodiments, the AMF supports N2 handover where the source and target gNBs connect via the same N2 connection. In some such embodiments, the UE Retention Information IE can be set to “ues-retained” in the NG setup request message using single or multiple IPv4 and/or IPv6 addresses for supporting SCTP multihoming.

In some embodiments, the gateway 102 interaction with the HgNB can support gateway configurations with multiple TNL addresses (e.g., SCTP endpoints) and honor TNL Address Usage and Weight Factor. In some embodiments, in case of a temporary loss of all SCTP associations established with the gateway 102, the HgNB can maintain UE information from previous SCTP associations, and set ues-retained in UE Retention Information IE in NG Setup Request message trying to keep all UE contexts when the HgNB reconnects to the gateway 102. In the illustrated example, the base stations 302, 304 can communicate with at least one of the gateway 102 or the core network 108 via a secure gateway 306 (identified by SeGW). For example, the SeGW 306 can protect the core network 108 by allowing only encrypted, authenticated, and/or authorized traffic to pass through.

In some embodiments, when an HgNB connects to the gateway 102, some functions are needed to achieve a seamless integration of 5G femtocells into the existing core network 108. For example, the HgNB can implement the discovery of a suitable serving gateway 102 initiating the NGAP setup procedure, connecting to only one gateway 102 simultaneously, setting the ConnectionMode parameter to One, not connecting at the same time to another gateway 102 or AMF entity because the HgNB may be deployed without a specific network plan. For example, an HgNB may be moved from one geographical area to another, and the HgNB may need to connect to a different gateway 102. In this procedure, the Tracking Area Code (TAC) and Public Land Mobile Network (PLMN) ID used by the HgNB is to be supported by the gateway 102.

In UE-related NGAP procedures, the AMF Selection Function at UE registration can be implemented by the gateway 102 as the HgNB includes the Globally Unique AMF ID (GUAMI) and GUAMI type received from the UE in the INITIAL UE MESSAGE. In some embodiments, the UE can send to the gateway 102 signaling as well the 5G-S-TMSI and/or AMF Set ID of the previous serving AMF in the INITIAL UE MESSAGE.

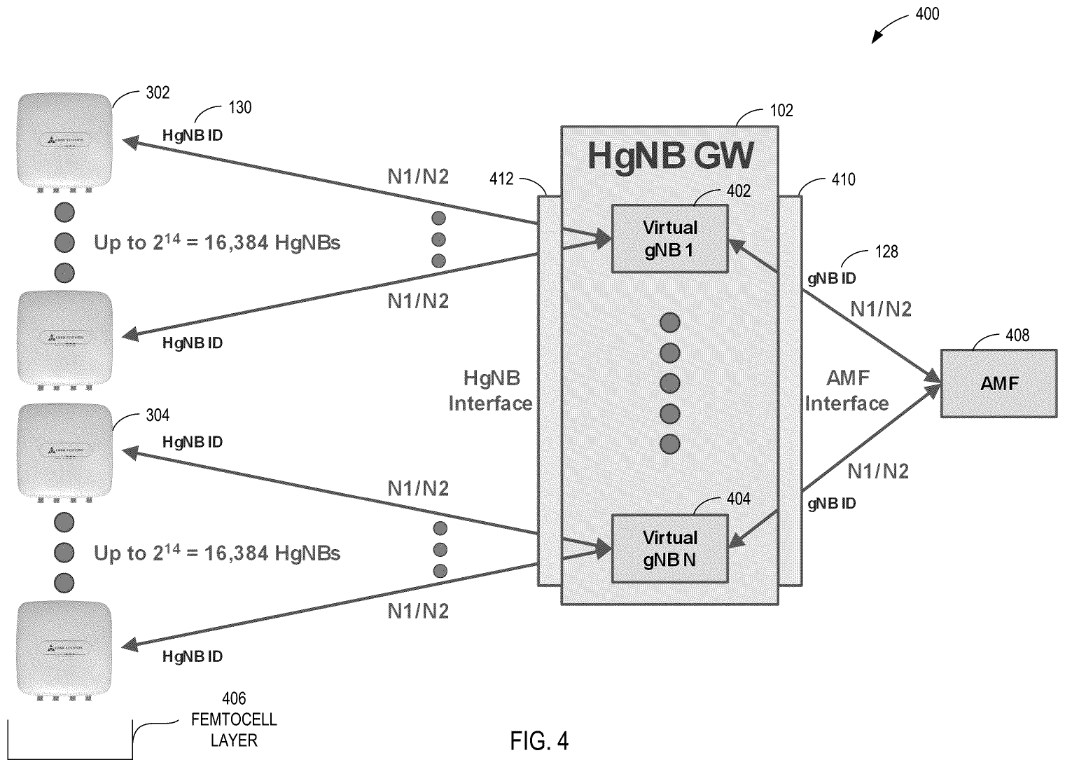

FIG. 4 is an illustration of another example wireless environment 400 including the gateway 102 of FIG. 1 implementing a plurality of example virtual nodes 402, 404 (identified by Virtual gNB 1, Virtual gNB N). In some embodiments, the wireless environment 400 can correspond to and/or implement the wireless environment 100 of FIG. 1, the wireless environment 200 of FIG. 2, and/or the wireless environment 300 of FIG. 3.

In the illustrated example, the gateway 102 abstracts the different HgNBs deployed in a 5G femtocell layer 406 from the 5G core by abstracting the different HgNBs into the virtual nodes 402, 404. The gateway 102 can effectuate an aggregation function by serving as a concentrator of large numbers of HgNBs, which substantially reduces the number of SCTP associations on an AMF 408 hosted by the 5G core. As such, HgNBs connect to the gateway 102 via the N2 interface using the HgNB ID 130, with the gateway 102 aggregating these links and connecting to the AMF 408 via the N2 interface. In some embodiments, the gateway 102 is delegated the NAS Node Selection Function (NNSF) to support NG-Flex or multiple NGAP connections towards the 5G core.

In the illustrated example, the gateway 102 can implement the Next Generation Application Protocol (NGAP) interface for a transparent connection between the femtocell layer 406 and the 5G core (e.g., the AMF 408). The NGAP interface between the HgNB and the 5G core is the same, regardless of whether the HgNB is connected to the 5G core via the gateway 102 and the Paging Optimization and Filtering Paging messages to avoid paging distribution to HgNBs or the Close Access Group (CAG) cells where the UE is not registered.

In some embodiments, as a control plane aggregator, the gateway 102 can appear and/or be represented to the AMF 408 and SMF as a gNB and appear and/or be represented to the HgNB as the AMF 408 and SMF. The NGAP interface between the HgNB and the 5G core is the same, regardless of whether the HgNB is connected to the 5GC via the gateway 102. Thus, the gateway 102 connects to the 5G core so that inbound and outbound mobility to femtocells served by the gateway 102 may not necessarily require inter-AMF handovers. Beneficially, this aggregation simplifies the deployment of low-cost 5G NR small cells, which include the femtocell layer 406, enables intra-gNB mobility, and optimizes and/or otherwise improves the signaling towards the 5G core by keeping the handover signaling within the logical gNB in the gateway 102 implementing an intra-gNB handover.

In some embodiments, the aggregation level implemented in the gateway 102 can depend on the ID lengths configured for gNBs and HgNBs as the ID conversion and/or transformation can provide the number of N2 interfaces that are aggregated in a virtualized logical gNB (e.g., the virtual nodes 402, 404) on the gateway 102 towards the AMF 408 in a single N2 interface. By way of example where the length of the HgNB ID 130 is set to 36-bits with up to one cell per HgNB and the length of the gNB ID 128 is set to 22-bits, the maximum aggregation factor is then 2⁽³⁶⁻²²⁾=2¹⁴=16,384 as shown in FIG. 4. In some embodiments, the virtual nodes 402, 404 can be and/or be represented as virtual wireless base stations such that the AMF 408 interacts with the virtual nodes 402, 404 as though they are physical wireless base stations.

In the illustrated example, the gateway 102 can deploy several instances of virtual logical gNBs shown as the virtual nodes 404, 404 to aggregate a substantial number of HgNBs, which may only be limited by the cloud resources available in the mobile network edge cloud. The example implementation of the gateway 102 shown in FIG. 4 includes at least two service interfaces including a first interface 410 and a second interface 412. In this example, the first interface 410 can implement the connectivity towards the AMF 408 and/or, more generally, the 5G core. For example, the first interface 410 can be an AMF interface configured to effectuate communication between the gateway 102 and the AMF 408. In this example, the second interface 412 can implement the connectivity towards the base stations 302, 304 and/or, more generally, the 5G femtocell RAN implemented at least in part by the femtocell layer 406. For example, the second interface 412 can be an HgNB interface configured to effectuate communication between the gateway 102 and ones of the base stations 302, 304. Beneficially, in some embodiments, the interfaces 410, 412 can be deployed in independent network segments for implementation of different routing policies and configuration of independent network settings. For example, the interfaces 410, 412 can have one or more IP addresses for implementing multihoming and multi-TNLA operation to increase the service reliability.

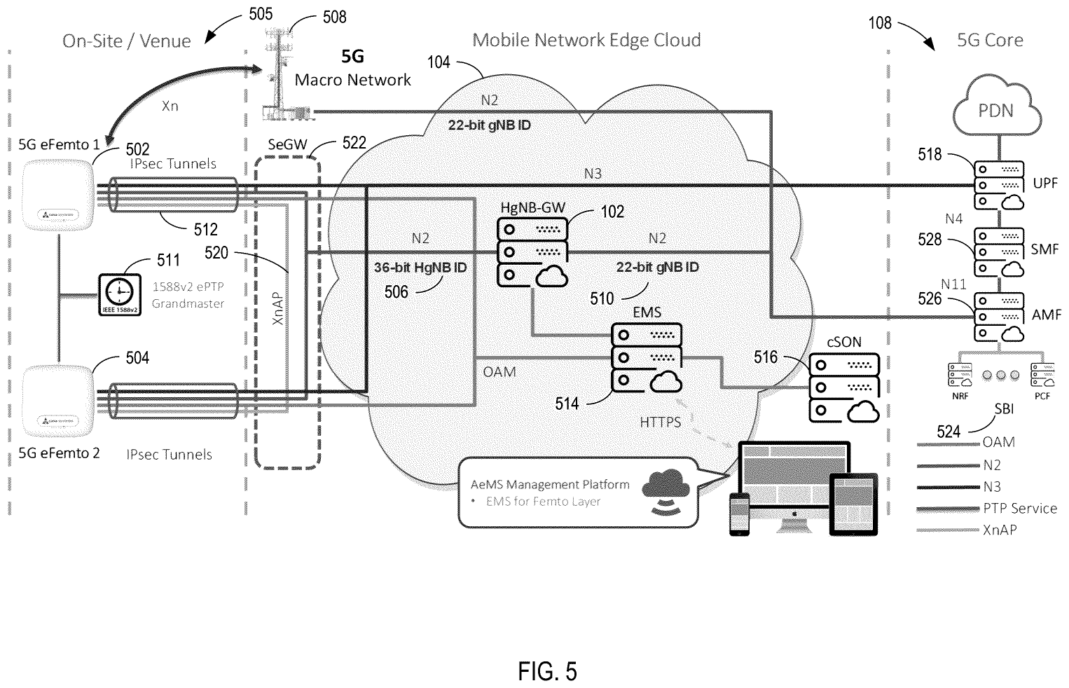

FIG. 5 is an illustration of example implementations of the mobile network edge cloud 104 of FIGS. 1 and/or 2 and the core network 108 of FIGS. 1 and/or 3. For example, FIG. 5 illustrates an evolved 5G advanced heterogeneous network architecture assuming that HgNBs implemented by respective 5G femtocells 502, 504 (identified by 5G eFemto 1 and 5G eFemto 2) in an environment 505 (identified by On-Site/Venue, such as a residential, commercial, or industrial site or venue) are using a 36-bit HgNB ID 506 and a macro gNB 508 implemented by a 5G macro network (e.g., one or more cell towers, one or more RRUs) is using a 22-bit gNB ID 510 where the interaction between the gateway 102 and the macro gNB 508 in terms of N2 mobility is shown. For example, the HgNB ID 506 of this example can correspond to and/or implement the HgNB ID 130 of FIG. 1. In some embodiments, the gNB ID 510 of this example can correspond to and/or implement the gNB ID 128 of FIG. 1.

The wireless environment 500 of this example includes a synchronization source 511, which is shown as an IEEE 1588v2 precision time protocol (PTP) Grandmaster Clock, to synchronize the 5G femtocells 502, 504. Any other type of synchronization source is contemplated. Also shown is the securing of the backhaul interfaces using Internet Protocol security (IPsec) tunnels 512, the different traffic flows and the interaction with other network functions and the integration of an EMS 514 with a Centralized Self-Organizing Network (cSON) function 516 that provides network configurations for supporting non-planned zero-touch plug and play algorithms to minimize and/or otherwise reduce the deployment cost adapting the HgNB configuration to the specific location and network environment where the device is deployed.

The wireless environment 500 of this example shows the evolved 5G network functions for a single carrier 5G Femto (e.g., the 5G femtocells 502, 504 are associated with the same mobile network carrier) that uses independent processing chains and radiofrequency (RF) paths for each multiple input, multiple output (MIMO) channel. Each of the 5G femtocells 502, 504 of this example can include a plurality of antennae for each RF path. The 5G femtocells 502, 504 can utilize several ones of the IPsec tunnels 512 using independent Security Associations (SAs) negotiated by Internet Key Exchange version 2 (IKEv2) and using a specific Tunnel ID based on a storage area network (SAN) entry of the SAN List that transports the control plane interface between the NG-RAN or non-3GPP WLAN and the core network 108 (N2), which can be the interface for conveying user data from the NG-RAN to the UPF 518 via the N3 interface. Also shown is an XnAP layer 520, which is an application layer signaling protocol used between 5G eFemtos 502, 504. Further depicted is a security gateway function 522 (identified by SeGW) that terminates IPsec Tunnels.

The mobile network edge cloud 104 of this example includes the gateway 102 that can implement one or more control-plane aggregation functions and/or serve as a concentrator for the control plane (C-Plane). In some embodiments, the gateway 102 may not modify the termination of the N3 (GPRS Tunneling Protocol (GTP)) or User Plane of the HgNB. In some embodiments, the EMS 514 function implements the OAM interface providing Fault, Configuration, Accounting, Performance, and Security (FCAPS) services to manage the 5G femtocell layer including the 5G femtocells 502, 504, the cSON function 516, or the cSON server that sets key network configurations based on the device location and other criteria to achieve a zero-touch plug and play procedure. In some embodiments, the core network 108 is configured with different network functions including the Service-Based Interface (SBI) 524 for integrating the 5G core functions.

In some embodiments, in the Hand-In procedure, a handover from the macro gNB 508 to an HgNB, after receiving a report from a UE, the macro gNB 508 derives a 22-bit gNB ID from the 36-bit NR Cell ID for specifying the Handover target, even when the target is a HgNB. The source macro gNB 508 can use the 22-bit target gNB ID in the HANDOVER REQUIRED message, or in UPLINK RAN CONFIGURATION TRANSFER message to route N2 messages in an AMF 526 of the core network 108.

In some embodiments, in the Hand-Out procedure to the macro layer, a handover from an HgNB to the macro gNB 508, after receiving a report from a UE including the 36-bit NR Cell ID, the HgNB can derive and/or determine a 22-bit gNB ID for the Handover target, using a discriminator (e.g., Physical Cell ID (PCI) range, Cell ID range) that instructs the radio resource management (RRM) of the HgNB to determine if the target is a macro gNB or an HgNB. Then, the source HgNB can use a 22-bit target gNB ID in HANDOVER REQUIRED or in UPLINK RAN CONFIGURATION TRANSFER messages when the discriminator classifies the neighbor as a macro gNB and 32-bit gNB IDs if the neighbor is classified as an HgNB.

In some embodiments, a role of the gateway 102 can be to provide an abstraction layer of the 5G femtocell RAN by consolidating the control-plane functions of individual HgNBs, particularly those associated with the N2 interface between the 5G femtocell RAN and the core network 108. In some embodiments, the aggregation of the user-plane (N3 interface) is optional and can be efficiently managed by the gateway 102. Beneficially, the gateway 102 can operate seamlessly by presenting itself as a gNB when communicating with the AMF 526 and SMF 528 functions of the core network 108. In contrast, when interacting with the HgNB, the gateway 102 can seamlessly transition by assuming the roles of the AMF 526 and the SMF 528 when presenting to the HgNB. Importantly, the N2 interface remains consistent, whether the HgNB is directly connected to the core network 108 or facilitated via the gateway 102. For example, the HgNB can be configured for implementing a single N2 interface towards a single logical gNB instance of a given gateway 102, which beneficially prevents concurrent connections with other gateway or AMF instances to strictly maintain the control plane coherence.

Beneficially, the integration of the gateway 102 within 5G networks signifies a transition to a new paradigm in next generation communication networks due at least in part to the remarkable scalability of the gateway 102 and its robust, reliable, and/or lightweight control-plane aggregation function capabilities.

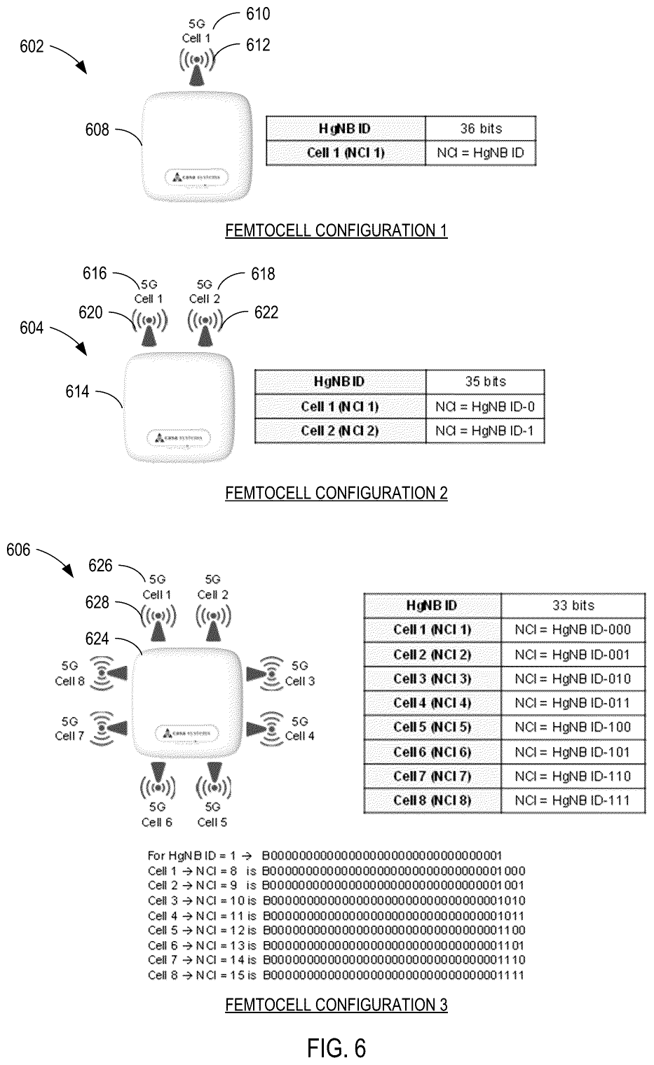

FIG. 6 is an illustration of a plurality of example femtocell configurations 602, 604, 606 including a first femtocell configuration 602, a second femtocell configuration 604, and a third femtocell configuration 606. Any other type of femtocell configuration is contemplated.

In the illustrated example, the first femtocell configuration 602 includes a first base station 608 configured to operate (e.g., operate as) and/or serve (e.g., serve as) a first femtocell 610 (identified by 5G Cell 1) using at least one antenna of the first base station 608. The first femtocell 610 of this example is a 5G femtocell. For example, the first base station 608 can be a first type of wireless base station. In some embodiments, the first type of wireless base station can be a femtocell base station (e.g., a wireless femtocell base station, a 5G femtocell base station) configured to operate as a femtocell and/or serve a femtocell.

The second femtocell configuration 604 includes a second base station 614 configured to operate a first femtocell 616 (identified by 5G Cell 1) and a second femtocell 618 (identified by 5G Cell 2) using at least a first antenna 620 and a second antenna 622 of the second base station 614. The first femtocell 616 and the second femtocell 618 of this example are 5G femtocells.

The third femtocell configuration 606 includes a third base station 624 configured to operate a plurality of femtocells 626 (identified by 5G Cell 1 through 5G Cell 8) using a plurality of antennae 628. The plurality of femtocells 626 in this example is a plurality 5G femtocells.

In the illustrated example, each of the femtocell configurations 602, 604, 606 has a corresponding configuration of the HgNB ID length that can be selected to support the number of 5G NR cells or carriers that the base station supports. For example, the number of cells can be independent of the number of RF paths that constitute the transmitter and receiver of the base station 608, 614, 624 for implementing MIMO RF interfaces. In some such embodiments, a cell can be specified by and/or based on the frequency allocation in both downlink and uplink directions and the bandwidth allocated to the cell. By way of example, a cell can have 2 receivers and 2 transmitters implementing a 2T2R cell or 8 receivers and 8 transmitters implementing an 8T8R cell.

The first femtocell configuration 602 illustrates an implementation of a 5G femtocell that supports one 5G cell and one 5G carrier and/or operator. In this example, if the carrier/operator desire to optimize the ID allocation, is possible to use on the HgNB a 36-bit HgNB ID that matches the NR Cell Identity (NCI) of the cell served by the HgNB. By way of example, HgNB ID 1 can serve NCI 1 on the first femtocell 610 when the bitstream is translated into decimal values.

The second femtocell configuration 604 illustrates an implementation of a dual cell femtocell device, which includes two independent cells each with a different NCI. In this example, the carrier/operator can use a 35-bit Home gNB ID to distinguish both cells by the last bit of the NCI. By way of example, the Home gNB ID 1 can serve the NCI 1 on the first femtocell 616 and the NCI 2 on the second femtocell 618 when the bitstream is translated into decimal values.

The third femtocell configuration 606 illustrates an implementation of an eight-cell femtocell device, which includes eight independent cells each with a different NCI. In this example, the carrier/operator can use a 33-bit HgNB ID to distinguish all system cells by the last 3 bits of the NCI. By way of example, the HgNB ID 1 can serve the NCI 8 on 5G Cell 1, the NCI 9 on 5G Cell 2, the NCI 10 on 5G Cell 3, and so on when the bitstream is translated into decimal values.

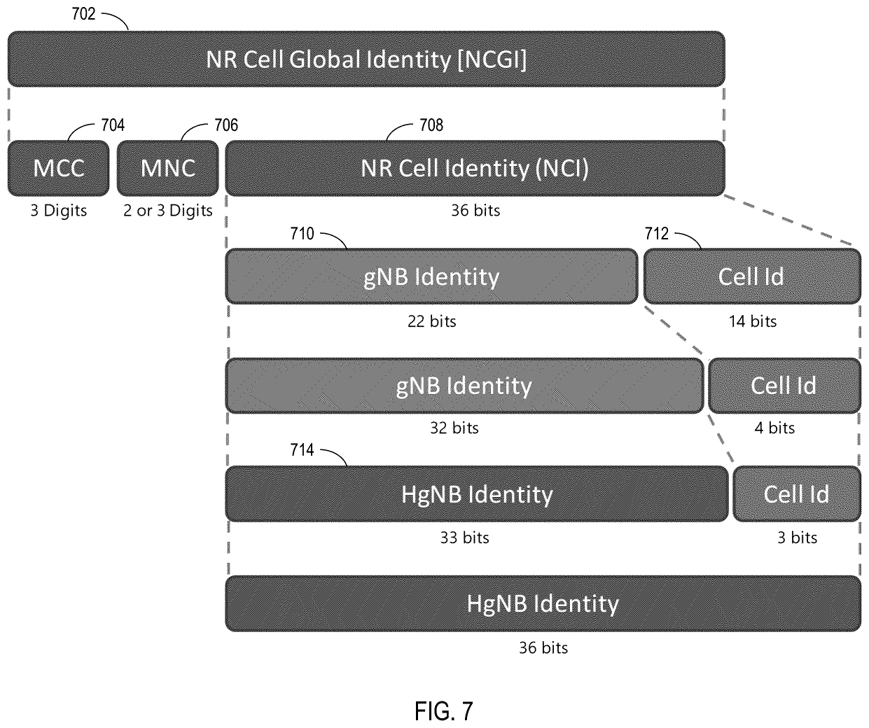

FIG. 7 is an illustration of an example implementation of a NR cell global identity (NCGI) 702 (also referred to as a NR cell global identifier). In some embodiments, the NCGI 702, or portion(s) thereof, can correspond to and/or implement the gNB identifier 128 of FIG. 1. In some embodiments, the NCGI 700, or portion(s) thereof, can correspond to and/or implement the HgNB identifier 130 of FIG. 1.

In some embodiments, the NCGI 702 identifies NR cells globally. The NCGI 702 of this example includes a mobile country code (MCC) 704, an MNC 706, and a NR cell identity (NCI) 708 (also referred to as a NR cell identifier). In some embodiments, the MCC 704 is a 3-digit code and/or identifier that can be used to identify a geographical country in which a mobile subscriber belongs (e.g., a user associated with UE). In some embodiments, the MNC 706 is a 2- or 3-digit code and/or identifier that can be used to identify a mobile network. In some embodiments, the MCC 704 and the MNC 706 together can form a public land mobile network (PLMN) code and/or identifier that can be used to identify a mobile network operator (carrier) using the Global System for Mobile communication (GSM), Universal Mobile Telecommunications System (UMTS), Long-Term Evolution (LTE), and/or 5G PLMNs. For example, the PLMN code for the NCGI 702 can be the first PLMN code within the set of PLMN codes associated with the NR cell identity in SIB1, following the order of broadcast.

In some embodiments, the NCI 708 is a 36-bit code and/or identifier that can be used to identify a cell (e.g., a wireless cell, a wireless network cell, a 5G NR cell). In the illustrated example, the NCGI 702 can be formed by concatenating the MCC 704, the MNC 706, and the NCI 708. Any other combination of the MCC 704, MNC 706, and/or the NCI 708 is contemplated.

The illustrated example of FIG. 7 depicts several embodiments of the NCI 708. In FIG. 7, the NCI 708 can include a gNB identity 710 (also referred to herein as a gNB identifier) and a cell identity 712 (also referred to herein as a cell identifier). In the illustrated example, the gNB identity 710 can be used to identify a gNB and can have a length in a range of 22-bits to 32-bits. Any other length of the gNB identity 710 is contemplated.

In the illustrated example, the cell identity 712 can identity a cell (e.g., a network cell, a mobile network cell, a wireless cell, etc.) and can have a length in a range of 4-bits to 14-bits such that, when combined with the gNB identity 710, the NCI 708 has a total length of 36-bits. Any other length of the cell identity 712 is contemplated.

In the illustrated example, the NCI 708 can include an HgNB identity 714 and/or the cell identity 712. For example, the HgNB identity 714 can be used to identify an HgNB and can have a length in a range of 33-bits to 36-bits. In embodiments in which the NCI 708 includes the HgNB identity 714 with a length of 33-bits, the NCI 708 can include the cell identity 712 with a length of 3-bits. In embodiments, in which the NCI 708 includes the HgNB identity 714 with a length of 36-bits, the NCI 708 may not include the cell identity 712.

In some embodiments, a global gNB ID for a gNB is formed and/or constructed from the PLMN identity the gNB belongs to and the gNB ID. The global gNB ID can be used to identify gNBs globally. The global gNB ID can also use the same MCC and MNC as included in the NCGI 702.

The global gNB ID can be specified by a global gNB ID Information Element (IE). In some embodiments, the global gNB ID is extended to include an HgNB ID type represented by a bitstring with a variable length limited by a range that does not collide with the existing information element specifications. Beneficially, this enhancement addresses the need of distinguishing macro gNBs from HgNBs while solving a fundamental limitation that HeNBs faced in 4G networks, as the enhancement allows HgNBs to support multiple cells, prepare the 5G standard to deploy in the future multiple mmWave and/or Tera-Hertz (THz) low power radios in a single logical device for enablement of carrier aggregation and multicell multiband wireless services. Beneficially, this enhancement represents a substantial advancement over HeNBs, which were limited to serving only one cell per unit. The inclusion of the HgNB ID in the global gNB ID IE provides the flexibility for HgNBs to deploy and manage up to eight cells per HgNB, expanding their capacity and adaptability. Beneficially, this enhancement expands the capacity and flexibility of HgNB deployments by permitting up to 8 cells per HgNB.

In some embodiments, the System Information Block Type 1 (SIB1) is extended to facilitate gNB and HgNB detection, enable using different ID lengths over a single 5G network to empower base station differentiation policies through the configuration of different gNB ID and HgNB ID lengths, and enable distinguishing of outdoor macros from outdoor and indoor small cells, residential and enterprise femtocells, and/or the like. In some embodiments, the PLMN-IdentityInfoList IE can incorporate a new IE that includes the gNB ID Length within the CellAccessRelatedInfo IE. The gNB ID Length can be specified as extended-gNB-ID-Length as an integer variable that can take a value from the 22-bit to 36-bit range as this value includes the lengths that the HgNB ID parameter can take. Beneficially, this improvement can empower the network to accurately discern several node types and enable efficient HgNB detection and integration as well as other advanced SON algorithms related with Multi-Connectivity and Traffic Steering based on node type classification.

In some embodiments, the NGAP interface specification is improved to support the deployment of HgNBs within 5G networks. These improvements represent an advancement in ensuring the seamless integration and efficient operation of HgNBs in 5G networks. Firstly, the NGAP Setup Procedure is upgraded as described herein to include the gateway 102, empower the gateway 102 to efficiently manage a substantial number of HgNBs, and thereby enhance the 5G network scalability and optimizing network operations in general. Such improvements to the NGAP Setup Procedure improves streamlining the network's ability to accommodate the growing deployment of HgNBs, which solves and/or otherwise overcomes the challenges faced in the previous generation (4G) where Home eNodeBs (HeNBs) could only serve a single cell.

In some embodiments, an id-AMF-UE-NGAP-ID-2 IE is utilized. This new IE introduced herein can implement a secondary unique ID for a UE control plane association for facilitating the routing of NGAP UE-associated messages from the gateway 102 to the AMF in mobility scenarios. In some embodiments, the id-AMF-UE-NGAP-ID-2 IE is configured exclusively for communication between the HgNB and the gateway 102, ensuring that the IE does not disrupt or impact the broader 5G core network and the existing 5G macro-RAN. Beneficially, this IE can streamline the flow of communication specific to HgNBs and enhance the efficiency of HgNB-related messaging without adding complexity to the 5G core network functions.

In some embodiments, the aforementioned improvements to the NGAP interface specification can make use of the Global RAN Node ID IE extension, which can include various procedures within the evolved 5G network architecture described herein including, but not limited to, Handover messaging to enforce multi-layer, multi-connectivity mobility including high capacity, low power HgNBs. Such an extension can facilitate the direct connection of HgNBs to the AMF to enable the AMF to also differentiate amongst node types for implementing several management procedures.

In some embodiments, the Xn Application Protocol (XnAP) is enhanced similarly as described for the NGAP protocol to support HgNBs in 5G networks, as this peer-to-peer interface is used in some scenarios where multi-connectivity is involved and thereby contributes to the evolution of 5G network capabilities extension and seamless integration as described herein. The extension of the Global RAN Node ID IE plays a role of this enhancement as the HgNB ID type can be used across multiple procedures and messages that include the Global gNB ID IE. This extension can be specified as a bitstring of 33-bits to 36-bits that are equal to the leftmost bits of the NR Cell Identity IE contained in the NR CGI IE of each cell served by the HgNB. This extension can also improve the signaling load and latency in mobility procedures, which can facilitate in several aspects the direct connection of HgNBs to the AMF due to the signaling re-balancing when this interface is implemented between HgNBs and macro gNBs.

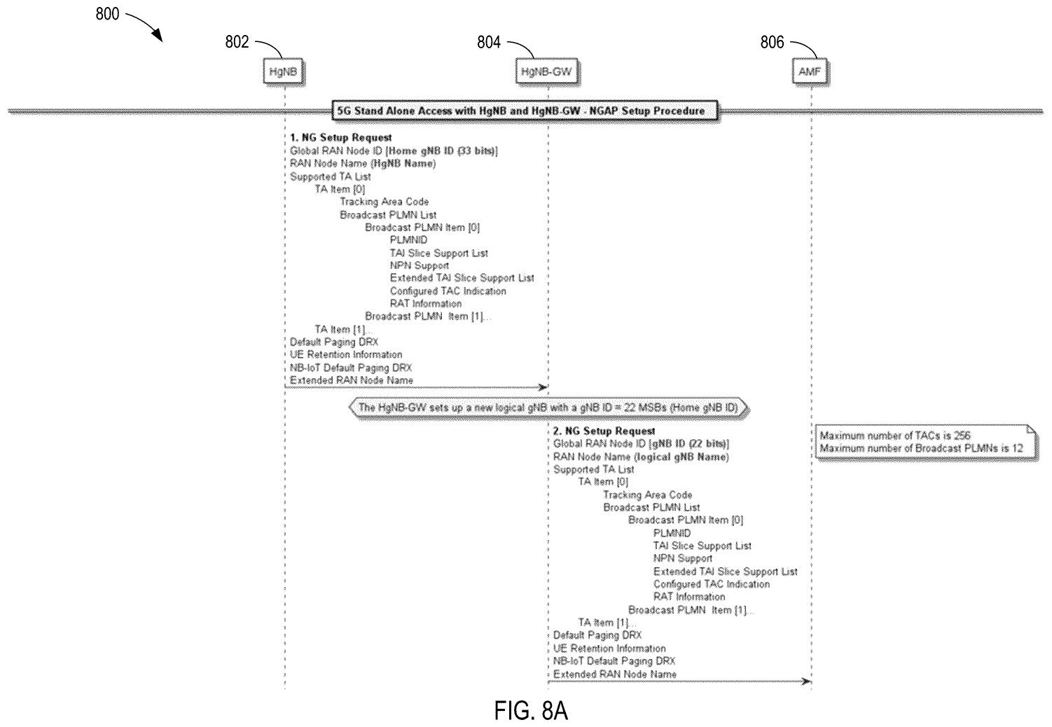

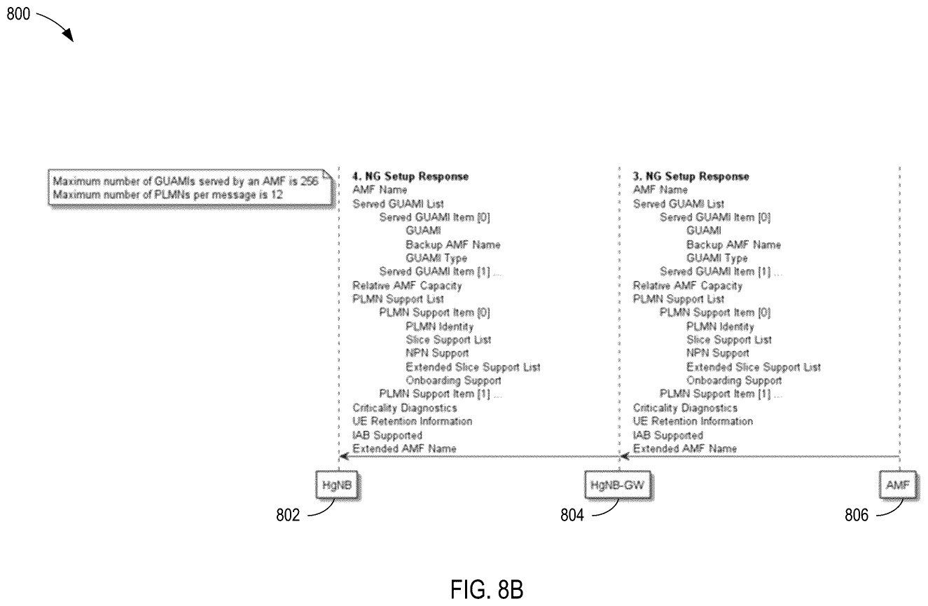

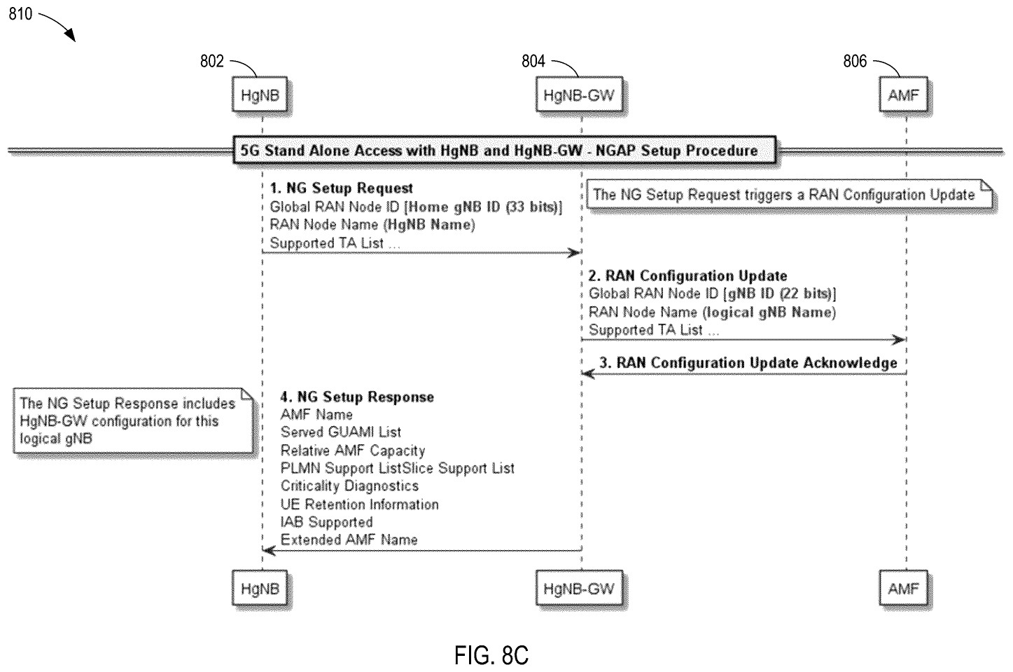

FIGS. 8A and 8B are illustrations of an example workflow 800 to configure the gateway 102 of FIGS. 1, 2, 3, 4, and/or 5. The workflow 800 includes operations by at least one of an HgNB 802, an HgNB-GW 804, and an AMF 806. In some embodiments, the HgNB 802 can correspond to the HgNB 118 of FIG. 1 and/or any other HgNB described herein. In some embodiments, the HgNB-GW 804 can correspond to the gateway 102 of FIGS. 1, 2, 3, 4, and/or 5. In some embodiments, the AMF 806 can correspond to the AMF 224 of FIG. 2 and/or any other AMF described herein.

The workflow 800 of this example illustrates the NGAP Setup Procedure that can introduce the gateway 102 (e.g., the HgNB-GW) when the logical gNB has not yet setup the N2 interface with the core network 108. The workflow 800 begins at a first operation when the HgNB initiates the call flow by sending an NG Setup Request to the gateway 102 to initiate the N2 Setup procedure using a Global RAN ID with a 33-bit Home gNB ID a unique global identifier. During a second operation, as there is no other logical gNB using a gNB ID=22 MSBs (HgNB ID), the gateway 102 sets a new virtualized logical gNB that can be setup with the AMF. Accordingly, the gateway 102 sends an NGAP Setup Request to the AMF to setup the NG interface for this new logical gNB using a 22-bit gNB ID. During a third operation, the AMF responds with an NG Setup Response message including the AMF name and the Served GUAMI List. Each serving GUAMI may include a Backup AMF Name that the gateway 102 can consider when performing the AMF reselection. During a fourth operation, the gateway 102 responds to the HgNB sending an NGAP Setup Response, which includes the AMF name and the Served GUAMI List. Each serving GUAMI may include a Backup AMF Name that the gateway 102 can consider when performing the AMF reselection considering that the maximum number of GUAMIs served by an AMF is 256 and the maximum number of PLMNs per message is 12 in this example.

In the illustrated example, the gateway 102 in this call flow initiates the NGAP setup procedure, implements a Global RAN Node ID translation between the 33-bit HgNB ID used by the HgNB and the 22-bit gNB ID used by the logical gNB, and establishes the control plane governed by the AMF. The gateway 102 in this example operates as an intermediary between the HgNB and the core network 108, facilitating the necessary communication for UE access to the 5G network. Beneficially, the gateway 102 operating as such an intermediary can enable the smooth operation of HgNBs within the evolved 5G network architecture as described herein.

In the call flow exemplified by FIGS. 8A and 8B, the gateway 102 translates the 33-bit HgNB ID into a 22-bit gNB ID to provide an aggregation layer to the 5G network architecture, which allows the operator to manage over a single NGAP interface up to 2,048 HgNBs or 5G femtocells over a single virtualized logical gNB instance using this specific configuration.

In some embodiments, the procedure exemplified by FIGS. 8A and 8B is implemented only the first time a virtualized logical gNB setups a NGAP interface with the core network 108, which corresponds to the first HgNB that belongs to the 22-bit gNB ID range. In some such embodiments, if an additional HgNB associated with the virtual gNB ID establishes a NGAP interface with the gateway 102, the gateway 102 will not forward a NGAP Setup Request but instead execute a RAN Configuration Update procedure updating the Served Cells information adding the new HgNB as described below in connection with FIG. 8C.

Then, during this procedure, the gateway 102 forwards the signaling information received from the HgNB in a transparent manner with the exception of the HgNB ID and the RAN Node Name, which can be translated into a name that is used for all the HgNBs associated with the virtual gNB instance.

FIG. 8C is an illustration of an example workflow 810 to configure the gateway 102 of FIGS. 1, 2, 3, 4, and/or 5. The workflow 800 includes operations by at least one of the HgNB 802, the HgNB-GW 804, and the AMF 806 of FIGS. 8A and 8B. FIG. 8C illustrates an NG Setup procedure initiated by the HgNB 802 using an HgNB ID that is served by a logical gNB instance that is using a gNB ID=22 MSBs (HgNB ID). In this example, the NG interface with the AMF for this particular logical gNB is already established, so that, the only required procedure is updating the configuration of this logical gNB, which is achieved through a RAN Configuration Update procedure described below.

During a first operation, the HgNB can send a NG Setup Request to the gateway 102 to initiate the N2 Setup procedure using a Global RAN ID with a 33-bit Home gNB ID a unique global identifier. During a second operation, as the logical gNB using a gNB ID=22 MSBs (HgNB ID) is already setup, the gateway 102 can send an NGAP RAN Configuration Update Acknowledge message to the AMF using a gNB ID of 22 bits forwarding the information sent by the HgNB. During a third operation, the AMF can respond with a RAN Configuration Update Acknowledge, informing the gateway 102 that its configuration has been updated. During a fourth operation, as the previous procedure has been successful, the gateway 102 can respond to the HgNB sending an NGAP Setup Response, which can include the AMF name and the Served GUAMI List. Each serving GUAMI may include a Backup AMF Name that the gateway 102 can consider when performing the AMF reselection considering that the maximum number of GUAMIs served by an AMF is 256 and the maximum number of PLMNs per message is 12.

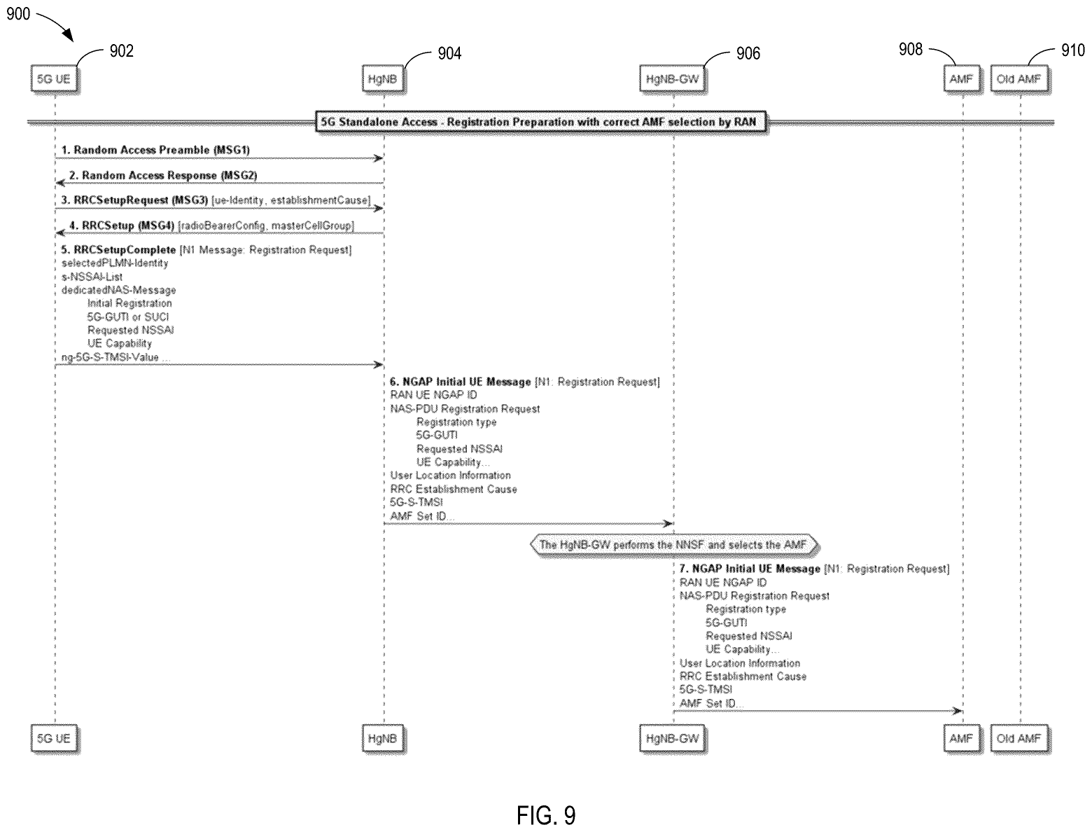

FIG. 9 is an illustration of an example workflow 900 to register UE with an AMF. The workflow 900 includes operations by at least one of a 5G UE 902, an HgNB 904, an HgNB-GW 906, a first AMF 908 (identified by AMF), and a second AMF 910 (identified by Old AMF). In some embodiments, the 5G UE 902 can correspond to the UE 110 of FIG. 1 and/or any other 5G UE described herein. In some embodiments, the HgNB 904 can correspond to the HgNB 118 of FIG. 1 and/or any other HgNB described herein. In some embodiments, the HgNB-GW 906 can correspond to the gateway 102 of FIGS. 1, 2, 3, 4, and/or 5. In some embodiments, the first AMF 908 and the second AMF 910 can correspond to different AMFs, such as a first instance and a second instance of the AMF 224 of FIG. 2 and/or any other AMF described herein.

The workflow 900 of this example illustrates the Registration Preparation Correct AMF Selection by RAN procedure using the gateway 102. During a first operation, the UE performs Random-Access Procedure sending a Random-Access Preamble message (MSG1). During a second operation, the HgNB responds with a Random-Access Response message (MSG2) to the UE providing an initial Radio Network Identifier. During a third operation, the UE sends a RRCSetupRequest message (MSG3) including the ue-identity and the establishmentCause. During a fourth operation, the HgNB responds with a RRCSetup message (MSG4) setting the SRB1. During a fifth operation, the UE responds with a RRCSetupComplete message including a NAS Registration Request with the 5G-GUTI or SUCI and the list of requested PDU sessions. During a sixth operation, the HgNB sends an N1 Registration Request in the NGAP Initial UE Message to the gateway 102. The gateway 102 selects an AMF based on AN parameters. If neither 5G-S-TMSI nor GUAMI is included in RRC Setup Complete AN parameters, the gateway 102 selects an AMF based on AN parameters. If the 5G-S-TMSI and/or GUAMI are included in RRC Setup Complete AN parameters, the gateway 102 selects an AMF based on 5G-S-TMSI and GUAMI included in AN parameters. If the gateway 102 cannot find AMF based on 5G-S-TMSI and/or GUAMI, the gateway 10 sends to a default AMF and if the 5G-S-TMSI, GUAMI and R-NSSAI are not provided, then the gateway 102 relies on a local default AMF configuration to select AMF. During a seventh operation, after performing NAS Node Selection Function and selecting the AMF, the gateway 102 forwards the NGAP Initial UE Message to the target AMF, ensuring that the correct AMF is selected by the RAN for the registration process.

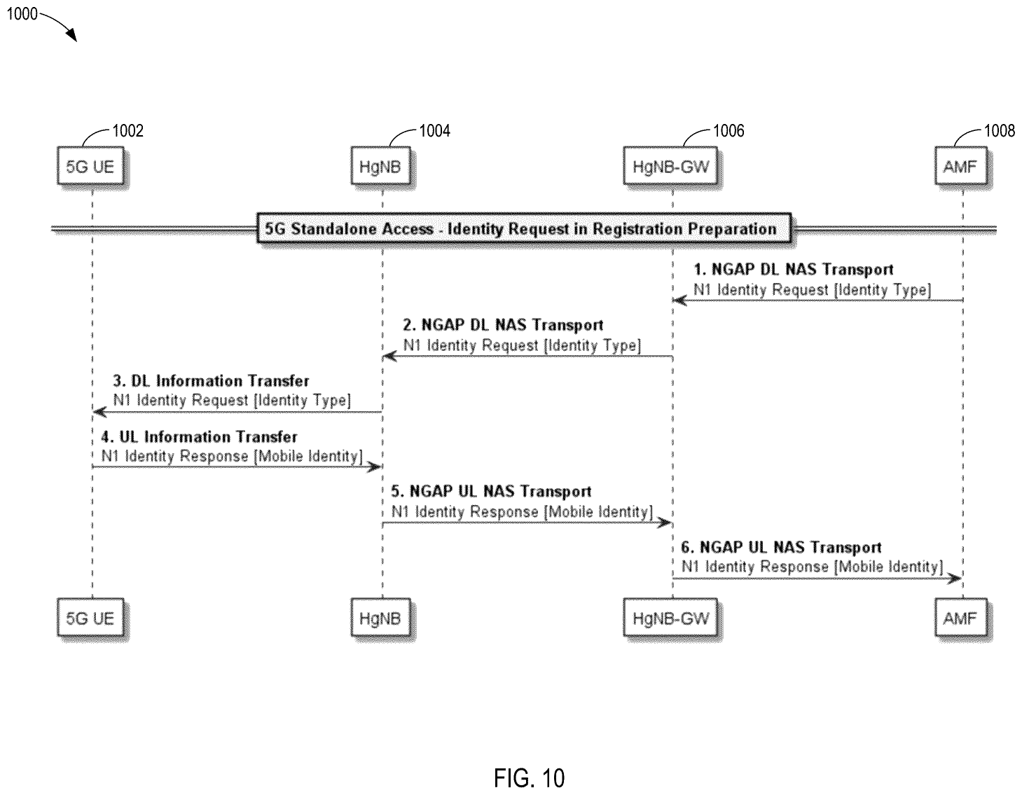

FIG. 10 is an illustration of an example workflow 1000 to identify user equipment in a wireless environment, such as the wireless environment 100 of FIG. 1. The workflow 1000 includes operations by at least one of a 5G UE 1002, an HgNB 1004, an HgNB-GW 1006, and an AMF 1008. In some embodiments, the 5G UE 1002 can correspond to the UE 110 of FIG. 1 and/or any other 5G UE described herein. In some embodiments, the HgNB 1004 can correspond to the HgNB 118 of FIG. 1 and/or any other HgNB described herein. In some embodiments, the HgNB-GW 1006 can correspond to the gateway 102 of FIGS. 1, 2, 3, 4, and/or 5. In some embodiments, the AMF 1008 can correspond to the AMF 224 of FIG. 2 and/or any other AMF described herein.

The workflow 1000 of this example illustrates the Identity Request procedure using the gateway 102. For example, the workflow 1000 can be executed and/or performed to request and confirm the identity of a UE within a network. The illustrated call flow can be initiated when the AMF requests to identify the UE for various purposes, such as authentication, tracking, and/or service provisioning. For example, the illustrated call flow can be performed and/or executed to identify the UE within a network, enable the network to provide services, authenticate the UE, and/or facilitate communication as required.

During a first operation of the workflow 1000, an AMF Request is performed such as by the AMF sending a N1 Identity Request specifying the Identity Type in the NGAP DL NAS Transport to the HgNB-GW. During a second operation, forwarding to the HgNB is performed such as where the gateway 102 forwards the request to the HgNB, which is responsible for interacting with the UE. During a third operation, a UE Request is performed such as where the HgNB instructs the UE to provide its identity by sending a N1 Identity Request specifying the Identity Type in DL Information Transfer.

During a fourth operation of the workflow 1000, a UE Response is performed such as where the UE replies to the HgNB with N1 Identity Response containing the Mobile Identity in the UL Information Transfer. During a fifth operation, forwarding to the gateway 102 is performed such as where the gateway 102 forwards the UE's identity response back to the AMF in NGAP UL NAS Transport. During a sixth operation, AMF Acknowledgment is performed such as where the gateway 102 sends the N1 Identity Response with the Mobile Identity in the NGAP UL NAS Transport.

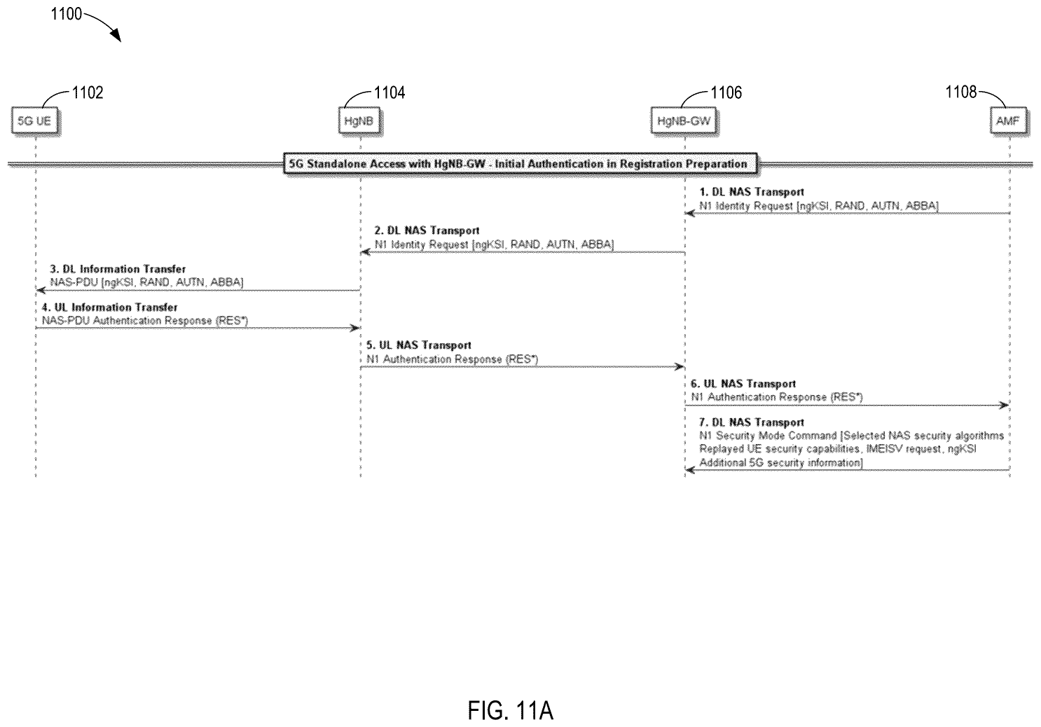

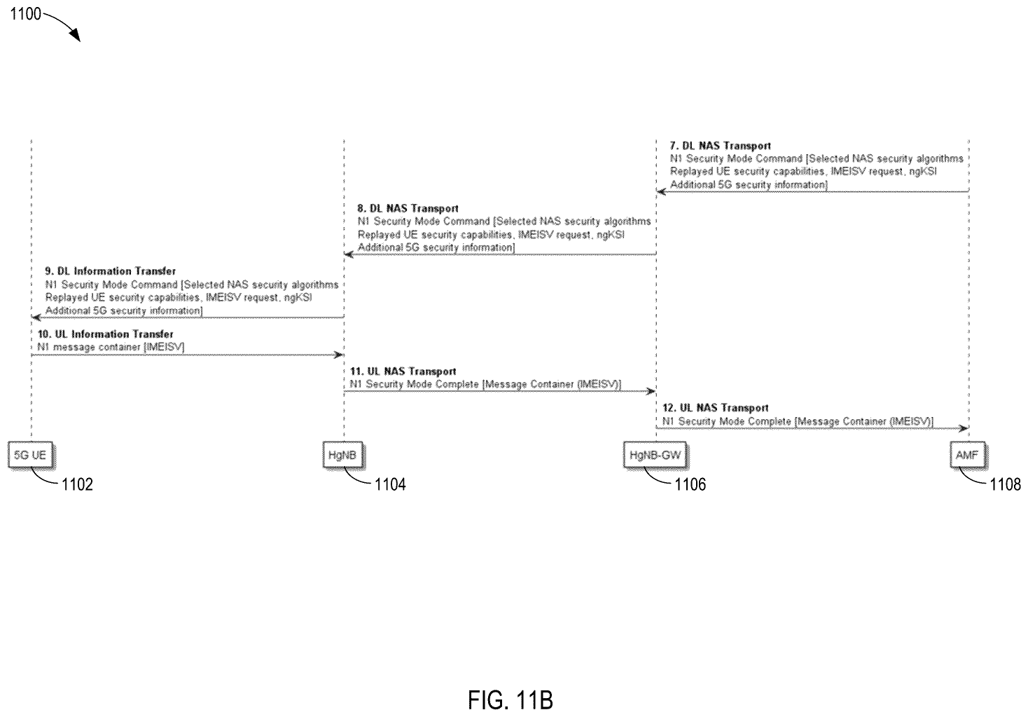

FIGS. 11A and 11B are illustrations of an example workflow 1100 to authenticate user equipment in a wireless environment, such as the wireless environment 100 of FIG. 1. The workflow 1100 includes operations by at least one of a 5G UE 1102, an HgNB 1104, an HgNB-GW 1106, and an AMF 1108. In some embodiments, the 5G UE 1102 can correspond to the UE 110 of FIG. 1 and/or any other 5G UE described herein. In some embodiments, the HgNB 1104 can correspond to the HgNB 118 of FIG. 1 and/or any other HgNB described herein. In some embodiments, the HgNB-GW 1106 can correspond to the gateway 102 of FIGS. 1, 2, 3, 4, and/or 5. In some embodiments, the AMF 1108 can correspond to the AMF 224 of FIG. 2 and/or any other AMF described herein.

The workflow 1100 of this example illustrates the Initial Authentication in Registration Preparation procedure, which included a plurality of operations to effectuate the authentication of a UE during registration preparation in a 5G network. During a first operation of the workflow 1100, the AMF sends a N1 Identity Request in the DL NAS Transport to the HgNB-GW. The message indicates the ngKSI, RAND, AUTN, and ABBA. During a second operation, the HgNB-GW forwards the previous DL NAS Transport message to the HgNB. During a third operation, the HgNB sends a NAS-PDU to the UE in the DL NAS Transport containing the ngKSI, RAND, AUTN, and ABBA. During a fourth operation, the UE replies to the HgNB with NAS-PDU Authentication Response (RES*) in the UL Information Transfer.

During a fifth operation of the workflow 1100, the HgNB forwards the NAS-PDU Authentication Response (RES*) to the HgNB-GW in the UL NAS Transport. During a sixth operation, the HgNB-GW forwards this UL NAS Transport message to the AMF. During a seventh operation, the AMF indicates the HgNB-GW the NAS security algorithms, Replayed UE security capabilities, IMEISV request, ngKSI, Additional 5G security information in the N1 Security Mode Command. During an eighth operation, the HgNB-GW forwards the message of a ninth operation to the HgNB. During the ninth operation, the HgNB forwards, as well, the message of a tenth operation to the UE using the DL Information Transfer. During the tenth operation, the UE send a N1 message container (IMEISV) in the UL Information Transfer to the HgNB. During an eleventh operation. the HgNB sends to the HgNB-GW N1 Security Mode Complete with Message Container (IMEISV). During a twelfth operation, the HgNB-GW forwards the N1 Security Mode Complete with Message Container (IMEISV) to the AMF. N1 Security Mode Complete message is ciphered, and integrity protected.

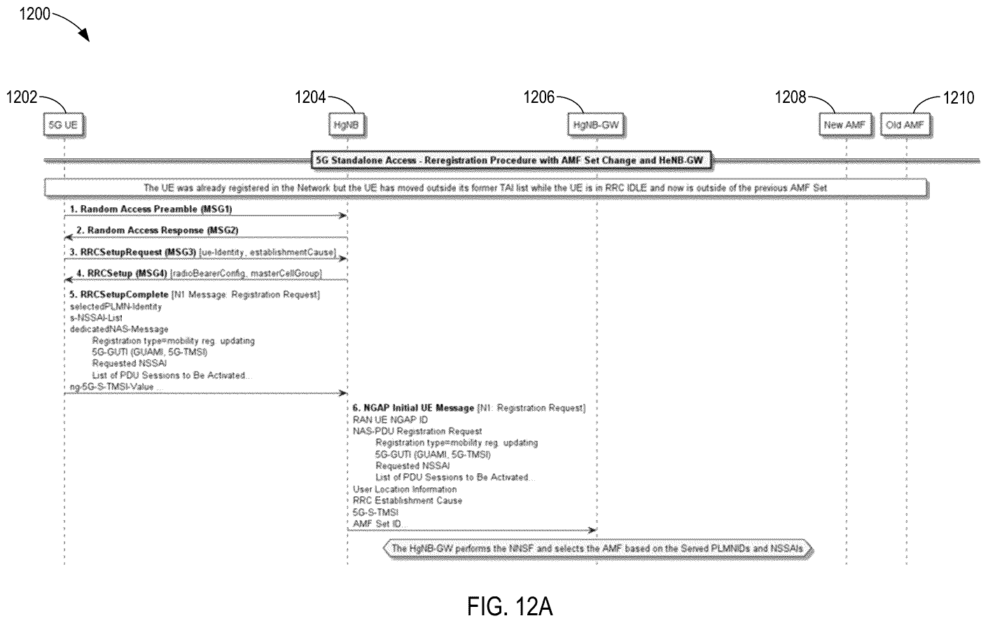

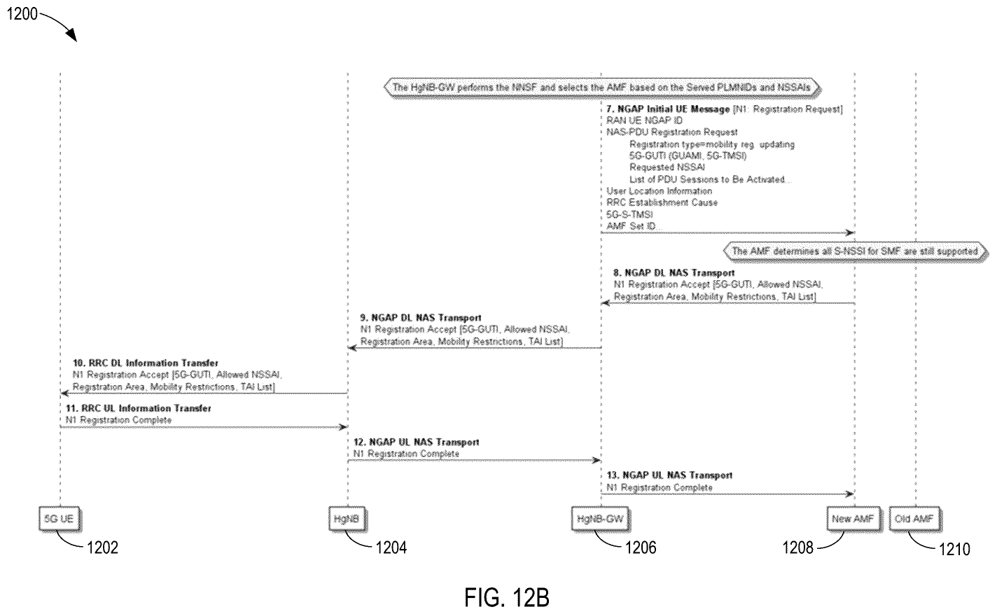

FIGS. 12A and 12B are illustrations of an example workflow 1200 to perform a handover of user equipment to a different access and mobility management function. The workflow 1200 includes operations by at least one of a 5G UE 1202, an HgNB 1204, an HgNB-GW 1206, a first AMF 1208 (identified by AMF), and a second AMF 1210 (identified by Old AMF). In some embodiments, the 5G UE 1202 can correspond to the UE 110 of FIG. 1 and/or any other 5G UE described herein. In some embodiments, the HgNB 1204 can correspond to the HgNB 118 of FIG. 1 and/or any other HgNB described herein. In some embodiments, the HgNB-GW 1206 can correspond to the gateway 102 of FIGS. 1, 2, 3, 4, and/or 5. In some embodiments, the first AMF 1208 and the second AMF 1210 can correspond to different AMFs, such as a first instance and a second instance of the AMF 224 of FIG. 2 and/or any other AMF described herein.

The workflow 1200 of this example illustrates the Registration Procedure with AMF Set Change using the HgNB-GW, which includes a plurality of operations for the registration and context transfer for a UE in a 5G network when a HgNB and a HgNB-GW are involved. During a first operation, the UE performs Random-Access Procedure sending a Random-Access Preamble message (MSG1). During a second operation, the HgNB responds with a Random-Access Response message (MSG2) to the UE providing an initial Radio Network Identifier. During a third operation, the UE sends a RRCSetupRequest message (MSG3) including the ue-identity and the establishmentCause. During a fourth operation, the HgNB responds with a RRCSetup message (MSG4) setting the SRB1. During a fifth operation, the UE responds with a RRCSetupComplete message including a NAS Registration Request with the 5G-GUTI or SUCI and the list of requested PDU sessions.

During a sixth operation, the HgNB sends a N1 Registration Request in the NGAP Initial UE Message to the HgNB-GW. During a seventh operation, the HgNB-GW sends a N1 Registration Request in the NGAP Initial UE Message, and performs the NNSF and selects the new AMF based on the Served PLMNIDs and NSSAIs. During an eighth operation, the new AMF send N1 Registration Accept in the NGAP DL NAS Transport to the HgNB-GW. During a ninth operation, the HgNB-GW forwards the message of step to the HgNB using the NGAP DL NAS Transport. During a tenth operation, the HgNB send N1 Registration Accept in RRC DL information Transfer to the UE. During an eleventh operation, the UE replies with N1 Registration Complete in RRC UL Information Transfer. During a twelfth operation, the HgNB forwards the NAS message of step 11 to the HgNB-GW in NGAP UL NAS Transport. During a thirteenth operation, the HgNB-GW sends a N1 Registration Complete to the new AMF in NGAP UL NAS Transport.

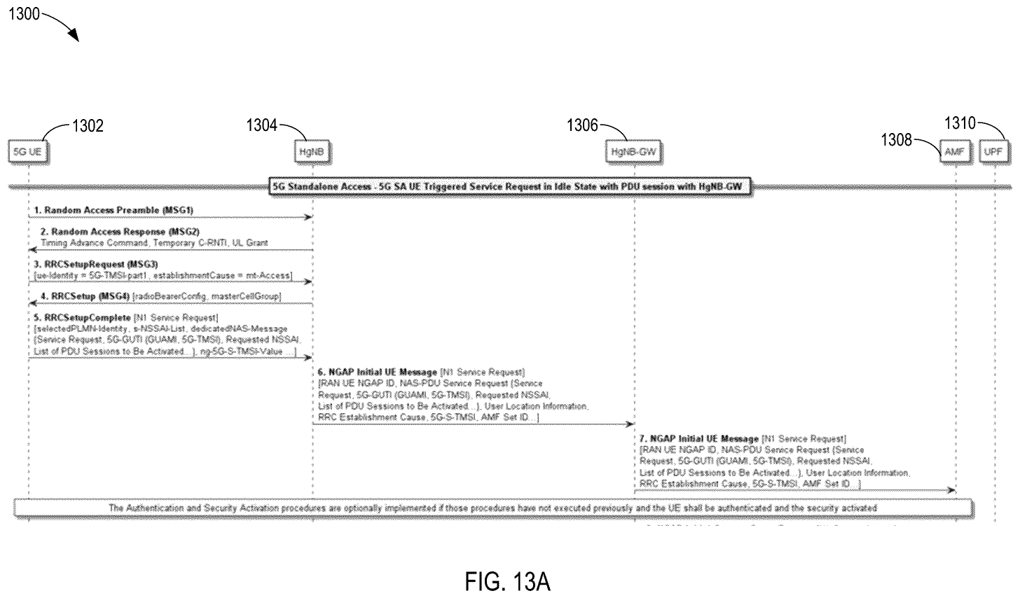

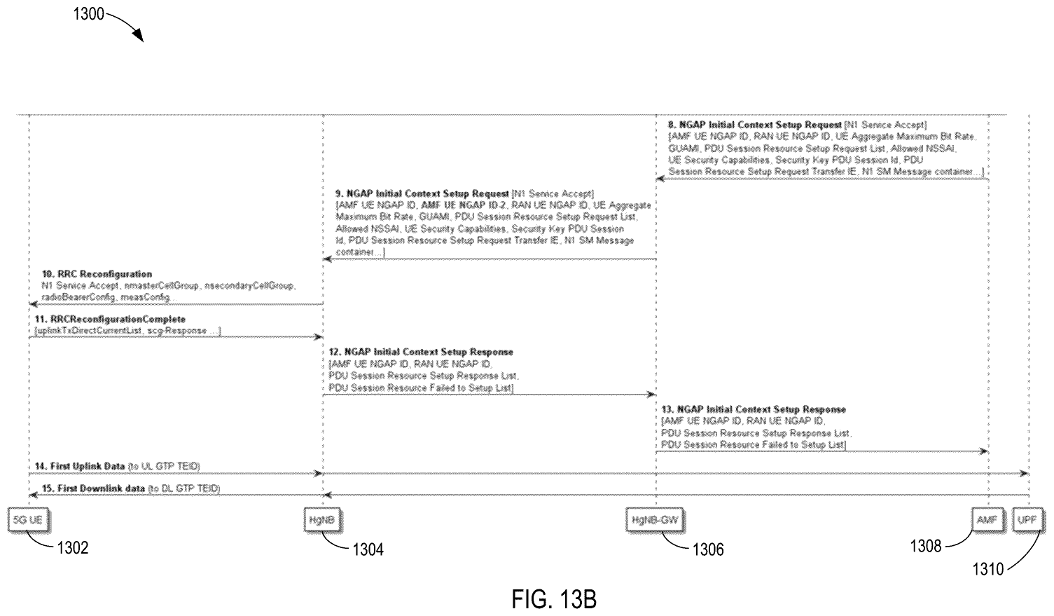

FIGS. 13A and 13B are illustrations of an example workflow 1300 to facilitate a user equipment service request. The workflow 1300 includes operations by at least one of a 5G UE 1302, an HgNB 1304, an HgNB-GW 1306, an AMF 1308, and a UPF 1310. In some embodiments, the 5G UE 1302 can correspond to the UE 110 of FIG. 1 and/or any other 5G UE described herein. In some embodiments, the HgNB 1304 can correspond to the HgNB 118 of FIG. 1 and/or any other HgNB described herein. In some embodiments, the HgNB-GW 1306 can correspond to the gateway 102 of FIGS. 1, 2, 3, 4, and/or 5. In some embodiments, the AMF 1308 can correspond to the AMF 224 of FIG. 2 and/or any other AMF described herein. In some embodiments, the UPF 1310 can correspond to the UPF 518 and/or any other UPF described herein. The use of the AMF-UE-NGAP-ID-2 IE in the workflow 1300 enables the network elements to efficiently manage and track UEs, especially in scenarios where multiple AMFs might be involved, such as during handovers or service requests.

The workflow 1300 of this example illustrates the 5G SA UE Triggered Service Request in Idle State without PDU Session procedure using the HgNB-GW. First through fourth operations of the workflow 1300 can be performed in accordance with one(s) of the above-described workflows. During a fifth operation, the UE sends to the HgNB an RRCSetup Complete with a N1 Service Request. During a sixth operation, the HgNB sends a NGAP Initial UE Message with N1 Service Request to the HgNB-GW. During a seventh operation, the HgNB-GW forwards the message to the AMF.

During an eighth operation, the AMF sends to the HgNB-GW a NGAP Initial Context Setup Request message with N1 Service Accept. During a ninth operation, the HgNB-GW sets the secondary UE identifier AMF UE NGAP ID-2 to be used between the HgNB-GW and the HgNB and includes it in the NGAP Initial Context Setup Request message that also carries the N1 Service Accept. During a tenth operation, the HgNB sends a RRC Reconfiguration message containing N1 Service Accept, masterCellGroup, secondaryCellGroup, radioBearerConfig, measConfig and other IEs. During an eleventh operation, the UE replies with RRCReconfigurationComplete including the uplinkTxDirectCurrentList, scg-Response and other IEs. During a twelfth operation, the HgNB sends a NGAP Initial Context Setup Response to the HgNB-GW. The message contains the AMF UE NGAP ID, RAN UE NGAP ID, PDU Session Resource Setup Response List, PDU Session Resource Failed to Setup List. During a thirteenth operation, the HgNB-GW forwards the Initial Context Setup Response to the AMF. During a fourteenth operation, the UE sends First Uplink data to the HgNB which forwards it to the UPF. During a fifteenth operation, the UPF sends the First Downlink data to the HgNB, which forwards this traffic to the UE.

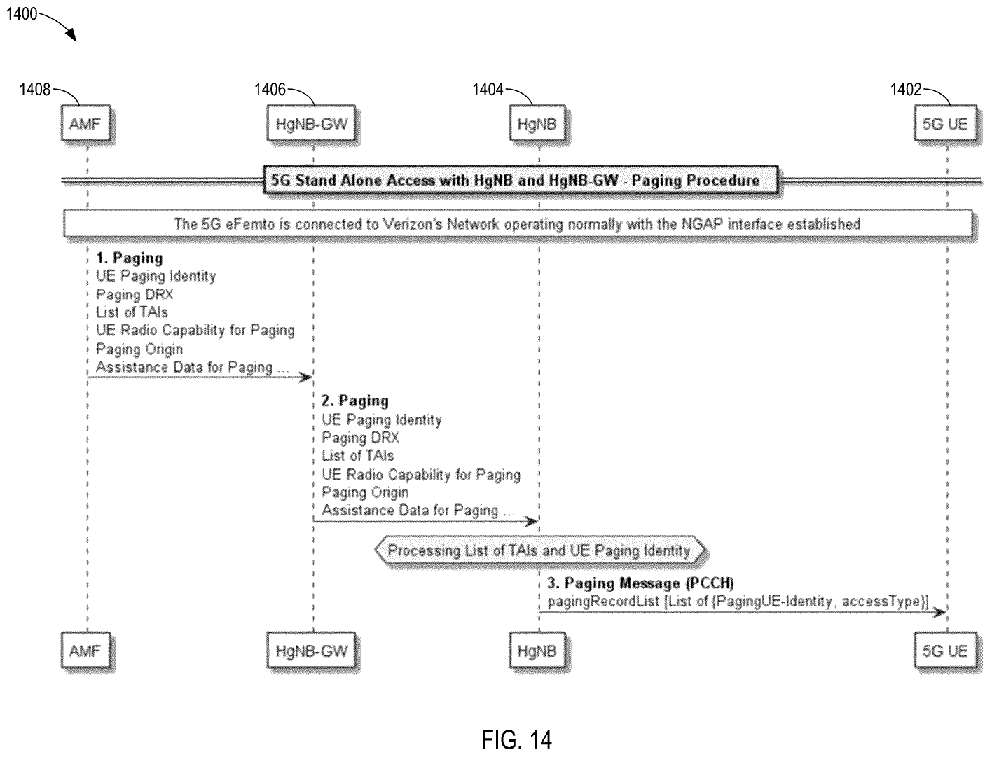

FIG. 14 is an illustration of an example workflow 1400 to implement a paging procedure. The workflow 1400 includes operations by at least one of a 5G UE 1402, an HgNB 1404, an HgNB-GW 1406, and an AMF 1408. In some embodiments, the 5G UE 1402 can correspond to the UE 110 of FIG. 1 and/or any other 5G UE described herein. In some embodiments, the HgNB 1404 can correspond to the HgNB 118 of FIG. 1 and/or any other HgNB described herein. In some embodiments, the HgNB-GW 1406 can correspond to the gateway 102 of FIGS. 1, 2, 3, 4, and/or 5. In some embodiments, the AMF 1408 can correspond to the AMF 224 of FIG. 2 and/or any other AMF described herein. In the call flow exemplified by the workflow 1400, the HgNB-GW can operate as an intermediary between the 5G core and the 5G femtocell RAN, which can optimize and/or otherwise improve the paging process to reach the UE in CM-IDLE state and ensuring efficient data delivery to the UE.

The workflow 1400 of this example illustrates the Paging Procedure when using the HgNB-GW. In the case of NR Paging, the UE is in RM-Registered State or in CM-IDLE state with 0, one or more PDU sessions. In some embodiments, the procedure can be triggered by the AMF itself or other network function (e.g., SMF).

During a first operation, the AMF sends to the HgNB-GW an N2 Paging message, including UE Paging Identity, Paging DRX, List of TAIs, UE radio Capability for Paging, Paging Origin and Assistance Data for Paging IEs. During a second operation, the HgNB-GW forwards the N2 Paging message of step 2 to the HgNB after processing the list of TAIs and UE identities, avoiding sending the Paging message to those HgNBs not serving the TAI. During a third operation, the HgNB process UE Paging Identity and performs paging of UEs in cells that belongs to tracking areas as indicated in the TAI List for Paging IE

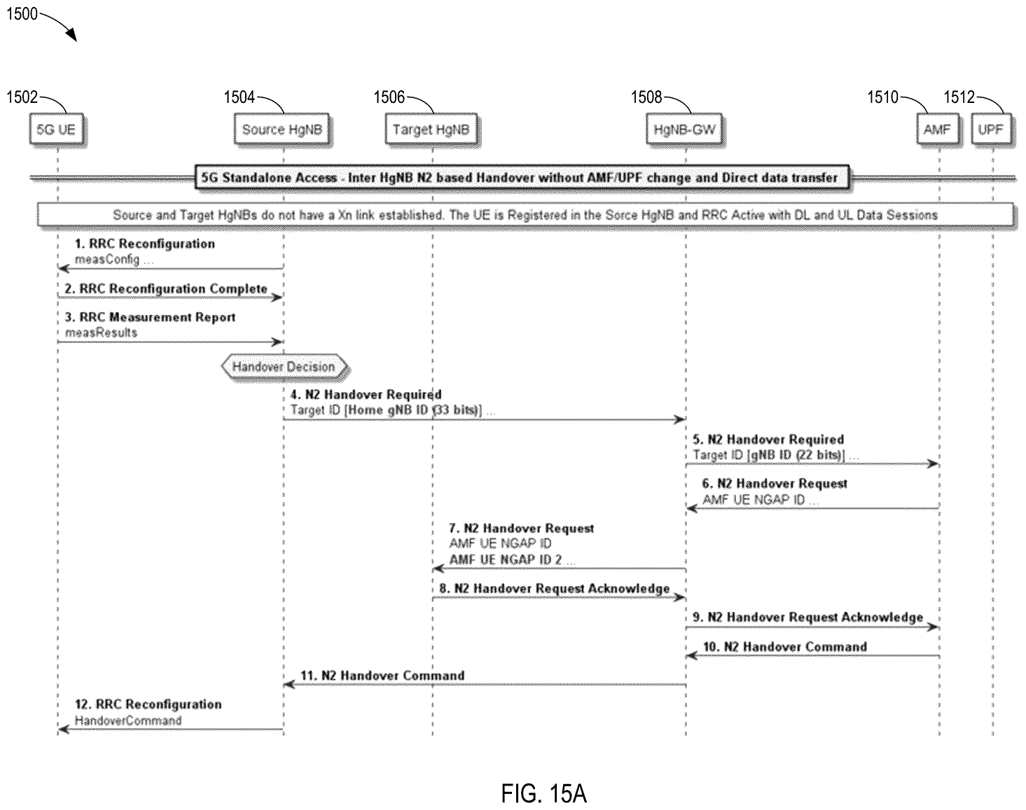

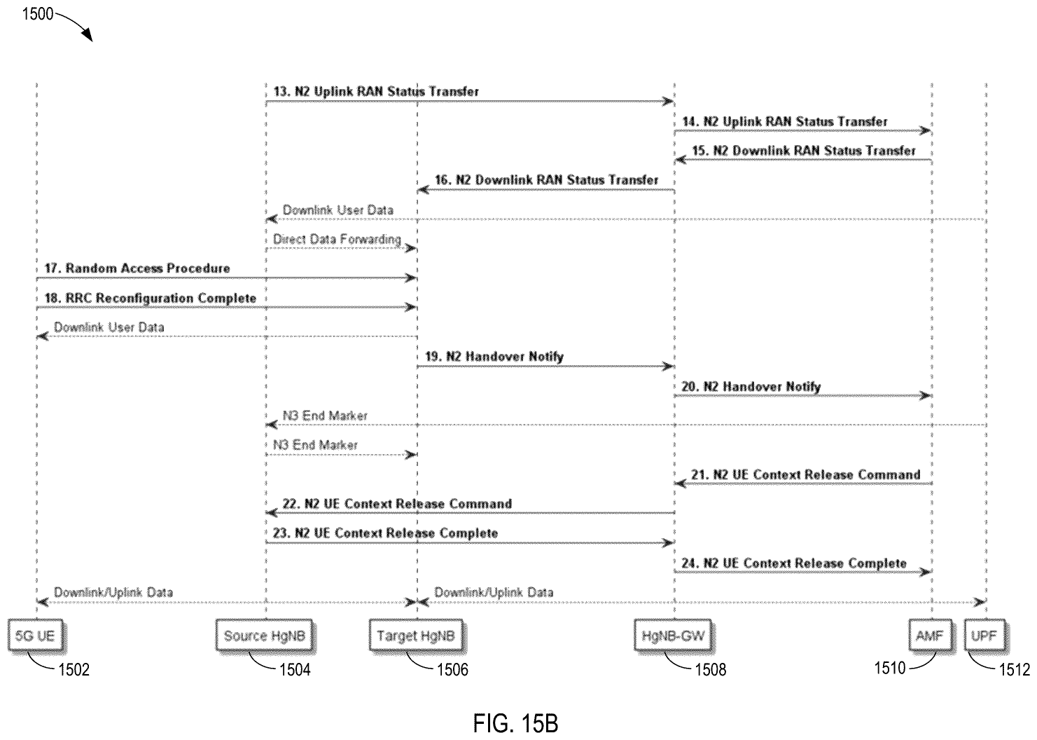

FIGS. 15A and 15B are illustrations of an example workflow 1500 to perform an indirect handover procedure. The workflow 1500 includes operations by at least one of a 5G UE 1502, a source HgNB 1504, a target HgNB 1506, an HgNB-GW 1508, an AMF 1510, and a UPF 1512. In some embodiments, the 5G UE 1502 can correspond to the UE 110 of FIG. 1 and/or any other 5G UE described herein. In some embodiments, the source HgNB 1504 and the target HgNB 1506 can correspond to different HgNBs, such as the HgNB 118 of FIG. 1 and/or any other HgNB described herein. In some embodiments, the HgNB-GW 1508 can correspond to the gateway 102 of FIGS. 1, 2, 3, 4, and/or 5. In some embodiments, the AMF 1510 can correspond to the AMF 224 of FIG. 2 and/or any other AMF described herein. In some embodiments, the UPF 1512 can correspond to the UPF 518 and/or any other UPF described herein

The illustrated example of FIGS. 15A-15B illustrates the N2 Indirect Handover without AMF Change including the HgNB-GW. In such an embodiment, the source HgNB can determine whether to initiate an N2-based handover to the target HgNB. This can be triggered, for example, due to new radio conditions or load balancing, if there is no Xn connectivity to the target HgNB, an error indication from the target HgNB after an unsuccessful Xn-based handover, and/or based on dynamic information learnt by the source HgNB.

In some embodiments, the availability of a direct forwarding path is determined in the source HgNB and indicated to the SMFs. If IP connectivity is available between the source and target NG-RAN and security association(s) is in place between them, a direct forwarding path is available. If a direct forwarding path is not available, indirect forwarding may be used. The SMFs use the indication from the source HgNB to determine whether to apply indirect forwarding. In the case of handover to a shared network, the source HgNB determines a PLMN to be used in the target network. The source NG-RAN can indicate the selected PLMN ID to be used in the target network to the AMF as part of the Tracking Area sent in the HO Required message. If the AMF generates the N2 downlink signaling during the ongoing handover and receives a rejection to an N2 interface procedure (e.g., DL NAS message transfer, location reporting control, etc.) from the NG-RAN with an indication that an Inter HgNB node handover procedure is in progress, the AMF may reattempt the same N2 interface procedure either when the handover is complete or the handover is deemed to have failed if the AMF is still the serving AMF, when possible. If the Inter HgNB node handover changes the serving AMF, the source AMF can terminate any other ongoing N2 interface procedures except the handover procedure.

If during the handover procedure the AMF detects that the AMF needs to be changed, the AMF can reject any SMF initiated N2 request received since handover procedure started and can include an indication that the request has been temporarily rejected due to handover procedure in progress. Upon reception for an SMF initiated N1 and/or N2 request(s) with an indication either from the HgNB (via N2 SM Info) or AMF that the request has been temporarily rejected due to handover procedure in progress, the SMF starts a locally configured guard timer. The SMF can hold any signaling messages targeted towards AMF for a given UE during the handover preparation phase unless it detects that the handover execution is completed, or handover has failed/cancelled. The SMF may re-attempt, up to a pre-configured number of times, when either it detects that the handover is completed or has failed using message reception or at expiry of the guard timer. For example, it can be assumed that the AMF has N2 associations with Source and Target HgNBs while the Source and the Target HgNBs do not have an Xn link established.

Turning to the workflow 1500 depicted in the illustrated examples of FIGS. 15A-15B, during a first operation in the RRC Reconfiguration, the Source HgNB configures the UE measurement procedures and the UE reports according to the measurement configuration. During a second operation, the UE acknowledge the accomplishment of the RRC Configuration in RRC Reconfiguration Complete. During a third operation, the UE sends a measurement report to the source HgNB in RRC Measurement Report. Based on those measurement the source HgNB decides to perform Handover. During a fourth operation, the Source HgNB to HgNB-GW sends a Handover Required including AMF UE NGAP ID, the Target ID using a Global RAN Node ID with Home gNB type and 33-bit length, Source to Target transparent container, PDU Session IDs, and Handover Type IEs. The Source to Target transparent container can include HgNB information created by Source HgNB to be used by Target HgNB and is transparent to 5GC. The container can also include for each PDU session the corresponding User Plane Security Enforcement information and QoS flows/DRBs information subject to data forwarding. All PDU Sessions handled by Source HgNB (e.g., all existing PDU Sessions with active UP connections) can be included in the Handover Required message, indicating which of those PDU Session(s) are requested by Source gNB to handover. The SM N2 info can include Direct Forwarding Path Availability if direct data forwarding is not available. Direct Forwarding Path Availability can indicate whether direct forwarding is available from the Source HgNB to the Target HgNB. This indication from Source HgNB can be based on the presence of IP connectivity and security association(s) between the Source HgNB and the Target HgNB. Based on Tracking Area and presence of N2 connectivity to Target HgNB, the AMF can determine that AMF change is not required.

During a fifth operation, the HgNB-GW forwards the Handover Required message to the AMF including the AMF UE NGAP ID, Target RAN ID with Global RAN Node ID with gNB type and 22-bit length, Source to Target transparent container, PDU Session IDs, Handover Type. During a sixth operation, the AMF sends an N2 Handover Request to the HgNB-GW including AMF UE NGAP ID, Handover Type, Cause, Source to Target Transparent Container, UE Aggregate Maximum Bit Rate, UE Security Capabilities, Security Context, GUAMI IEs.

During a seventh operation, the HgNB-GW forwards the N2 Handover Request to the Target HgNB including AMF UE NGAP ID, AMF UE NGAP ID-2, Handover Type, Cause, Source to Target Transparent Container, UE Aggregate Maximum Bit Rate, UE Security Capabilities, Security Context, and GUAMI. During an eighth operation, the Target HgNB replies with an N2 Handover Request Acknowledge to the HgNB-GW.

During a ninth operation, the HgNB-GW forwards the N2 Handover Request Acknowledge message to the AMF. During a tenth operation, the AMF sends a N2 Handover Command to the HgNB-GW. During an eleventh operation, the HgNB-GW forwards the N2 Handover Command to the Source HgNB. During a twelfth operation, the Source HgNB triggers the handover sending to the UE an RRC Reconfiguration message containing Handover Command message. During a thirteenth operation, the Source HgNB sends Uplink RAN Status Transfer message to the HgNB-GW for PDCP status preservation in RLC AM bearers in the Target HgNB. During a fourteenth operation, the HgNB-GW forwards the Uplink RAN Status Transfer message to the AMF.

During a fifteenth operation, the AMF sends a N2 Downlink RAN Status Transfer message to the HgNB-GW containing the PDCP status preservation in RLC AM bearers' information. During a sixteenth operation, the HgNB-GW forwards the N2 Downlink RAN Status Transfer message to the Target HgNB to convey PDCP SN status of bearers for which PDCP status preservation applies (e.g., for RLC AM). During a seventeenth operation, the UE triggers the Random-Access Procedure to connect to the Target HgNB.

During an eighteenth operation, once the UE synchronizes to the target cell and completes the RRC handover procedure, the UE sends a RRC Reconfiguration Complete message to the Target HgNB. In case the UE fails to send the RRC Reconfiguration Complete message to the Target HgNB due to a Radio Link Failure, the UE initiates a RRC Connection Re-establishment procedure sending a RRC Connection Re-establishment Request message to a HgNB, which could be the original Source HgNB, with the cause of Handover Failure. Now, the Target HgNB can start sending Downlink Data to the UE, and the UE can send Uplink Data to the UPF.

During a nineteenth operation, the Target HgNB sends a Handover Notify message to the HgNB-GW. Including the AMF UE NGAP ID IE. At this stage, the handover is considered as successful in the Target HgNB. During a twentieth operation, the HgNB-GW forwards the Handover Notify message to the AMF. During a twenty-first operation, the AMF sends to the HgNB-GW UE Context Release Command to release UE context at the Source HgNB including the AMF UE NGAP ID IE. During a twenty-second operation, the HgNB-GW forwards the UE Context Release Command message to the Source HgNB including the AMF UE NGAP ID IE. During a twenty-third operation, the Source HgNB sends to the HgNB-GW a UE Context Release Command Complete message to acknowledge the release of the UE Context including the AMF UE NGAP ID IE. During a twenty-fourth operation, the HgNB-GW forwards the UE Context Release Command Complete message to the AMF. After the twenty-fourth operation, downlink and/or uplink data can be transmitted in the 5G network.

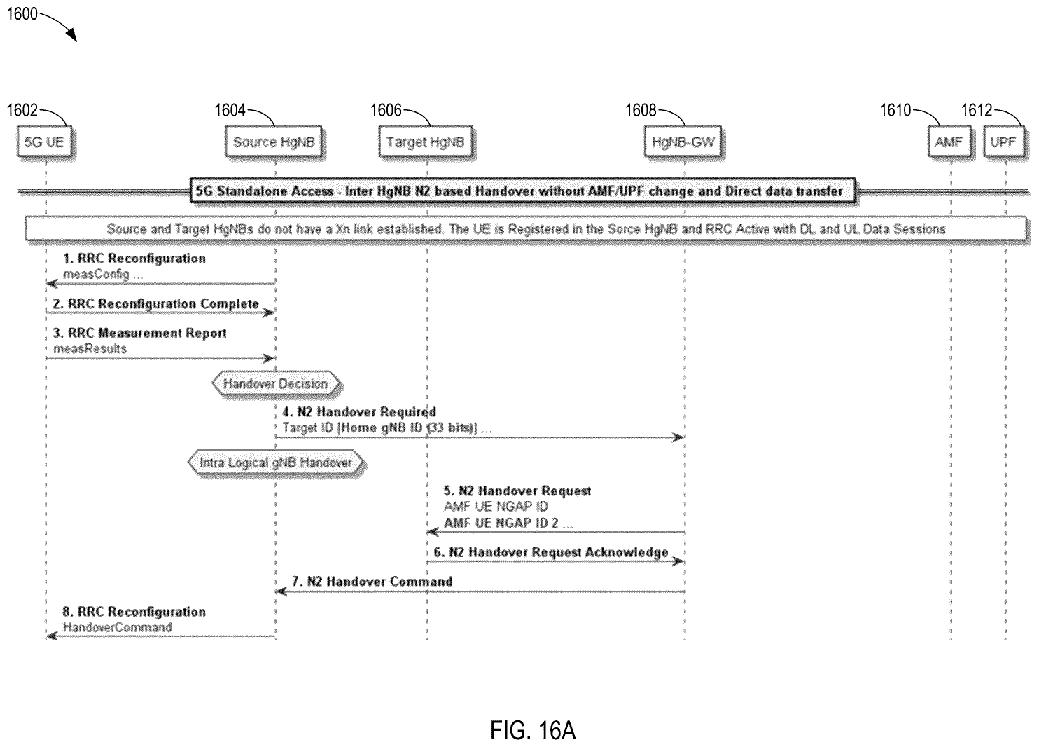

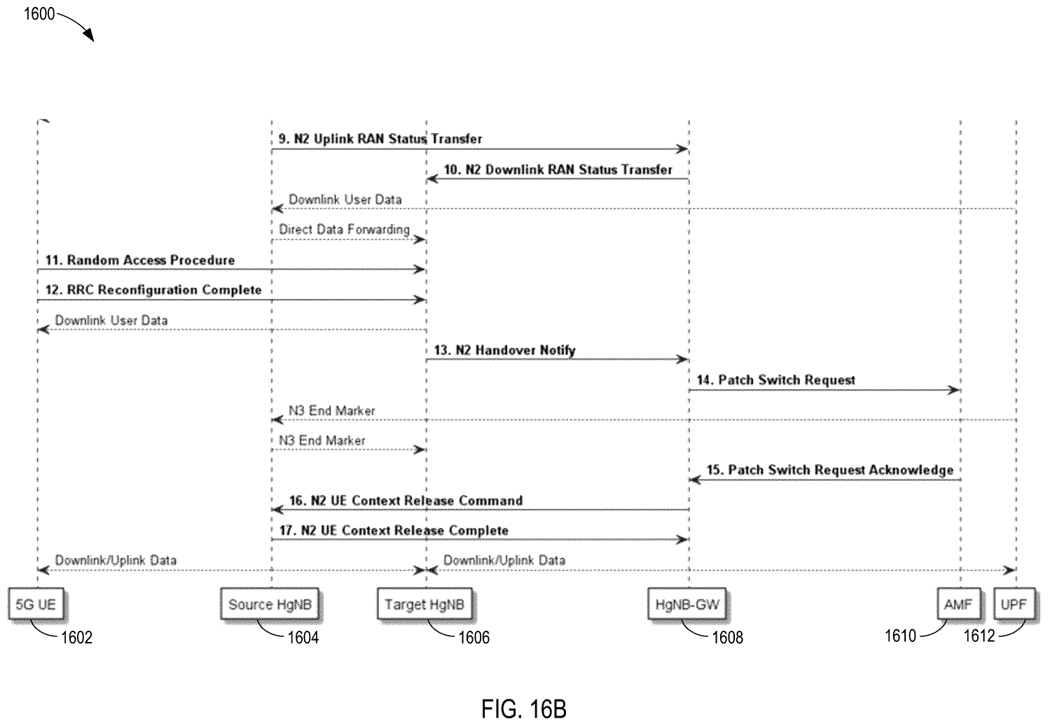

FIGS. 16A and 16B are illustrations of an example workflow 1600 to implement an inter-logical handover procedure. The workflow 1600 includes operations by at least one of a 5G UE 1602, a source HgNB 1604, a target HgNB 1606, an HgNB-GW 1608, an AMF 1610, and a UPF 1612. In some embodiments, the 5G UE 1602 can correspond to the UE 110 of FIG. 1 and/or any other 5G UE described herein. In some embodiments, the source HgNB 1604 and the target HgNB 1606 can correspond to different HgNBs, such as the HgNB 118 of FIG. 1 and/or any other HgNB described herein. In some embodiments, the HgNB-GW 1608 can correspond to the gateway 102 of FIGS. 1, 2, 3, 4, and/or 5. In some embodiments, the AMF 1610 can correspond to the AMF 224 of FIG. 2 and/or any other AMF described herein. In some embodiments, the UPF 1612 can correspond to the UPF 518 and/or any other UPF described herein.

The workflow 1600 illustrates an inter-logical gNB Handover in an example deployment scenario where the Source and the Target HgNBs do not have an Xn link established. During a first operation, in the RRC Reconfiguration, the Source HgNB configures the UE measurement procedures and the UE reports according to the measurement configuration. During a second operation, the UE acknowledge the accomplishment of the RRC Configuration in RRC Reconfiguration Complete. During a third operation, the UE sends a measurement report to the source HgNB in RRC Measurement Report. Based on those measurement the source HgNB decides to perform Handover. During a fourth operation, the Source HgNB to HgNB-GW sends a Handover Required including AMF UE NGAP ID, the Target ID using a Global RAN Node ID with Home gNB type and 33-bit length, Source to Target transparent container, PDU Session IDs, and Handover Type IEs. In this case, the Target HgNB is served by the same logical gNB in the HgNB-GW, so it detects that is an Intra Logical gNB Handover.

During a fifth operation, instead of forwarding the message to the AMF, for optimizing the signaling load, the HgNB-GW sends an N2 Handover Request to the HgNB-GW including AMF UE NGAP ID, AMF UE NGAP ID-2, Handover Type, Cause, Source to Target Transparent Container, UE Aggregate Maximum Bit Rate, UE Security Capabilities, Security Context, GUAMI, IEs, etc. During a sixth operation, the Target HgNB replies with an N2 Handover Request Acknowledge to the HgNB-GW. During a seventh operation, the HgNB-GW sends a N2 Handover Command to the Source HgNB. During an eighth operation, the Source HgNB triggers the handover sending to the UE an RRC Reconfiguration message containing the Handover Command message.

During a ninth operation, the Source HgNB sends Uplink RAN Status Transfer message to the HgNB-GW for PDCP status preservation in RLC AM bearers in the Target HgNB. During a tenth operation, the HgNB-GW forwards the N2 Downlink RAN Status Transfer message to the Target HgNB to convey PDCP SN status of bearers for which PDCP status preservation applies (i.e., for RLC AM). During an eleventh operation, the UE triggers the Random-Access Procedure to camp on the Target HgNB.

During a twelfth operation, once the UE synchronizes to the target cell and completes the RRC handover procedure, the UE sends a RRC Reconfiguration Complete message to the Target HgNB. In case the UE fails to send the RRC Reconfiguration Complete message to the Target HgNB due to a Radio Link Failure, the UE initiates a RRC Connection Re-establishment procedure sending a RRC Connection Re-establishment Request message to a HgNB, which could be the original Source HgNB, with the cause of Handover Failure. Now, the Target HgNB can start sending Downlink Data to the UE, and the UE can send Uplink Data to the UPF.

During a thirteenth operation, the Target HgNB sends a Handover Notify message to the HgNB-GW. Including the AMF UE NGAP ID IE. At this stage, the handover is considered as successful in the Target HgNB. During a fourteenth operation, the HgNB-GW sends a Path Switch Request message to the AMF to transfer some NG-U DL tunnel termination point(s) to the SMF via the AMF for one or multiple PDU session resources and then the UPF sends to the Source HgNB. During a fifteenth operation, the AMF sends to the HgNB-GW Path Switch Request Acknowledge message to accept the previous resource modification request. During a sixteenth operation, the HgNB-GW sends to the Source HgNB a UE Context Release Command message to release of the UE Context including the AMF UE NGAP ID IE. During a seventeenth operation, the Source HgNB responds with a UE Context Release Command Complete message to the HgNB-GW.

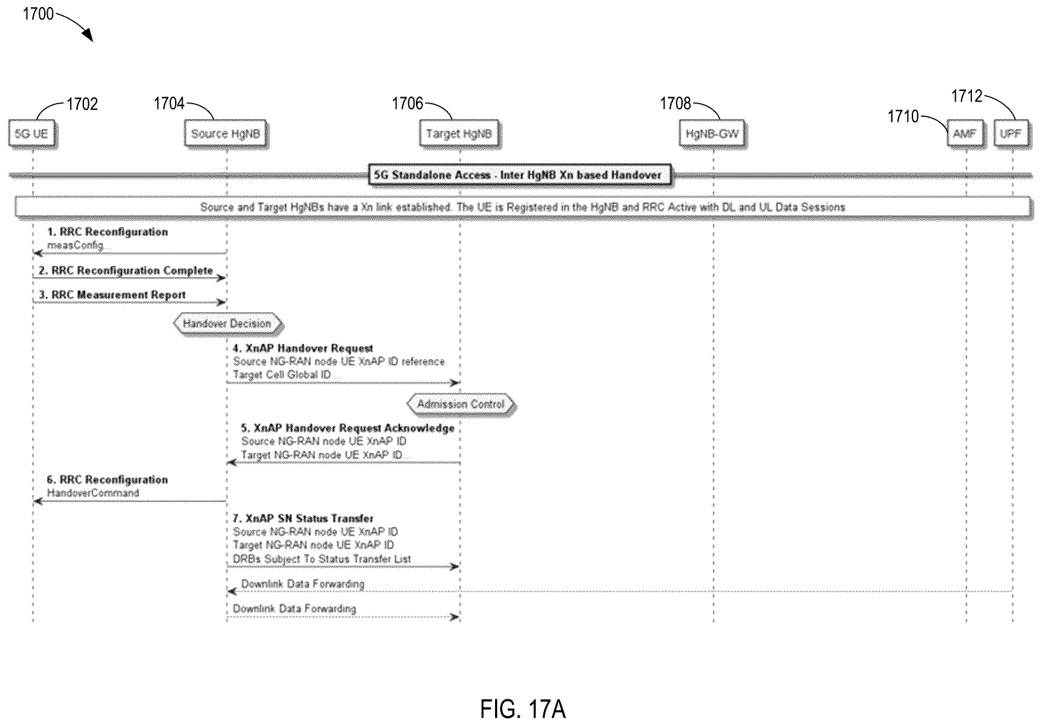

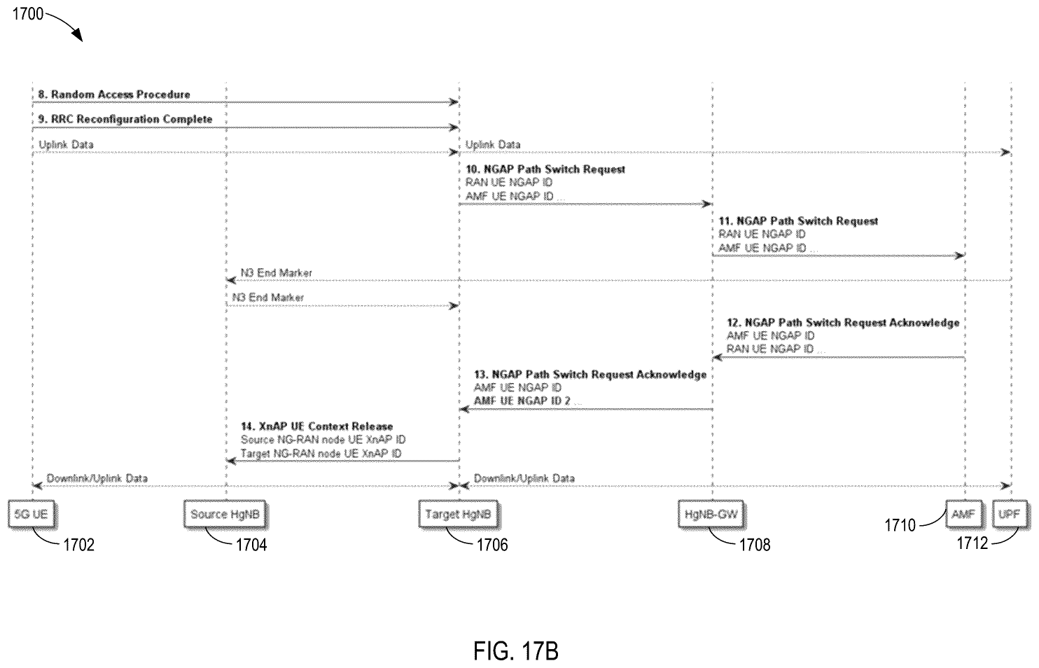

FIGS. 17A and 17B are illustrations of an example workflow 1700 to perform a direct handover procedure. The workflow 1700 includes operations by at least one of a 5G UE 1702, a source HgNB 1704, a target HgNB 1706, an HgNB-GW 1708, an AMF 1710, and a UPF 1712. In some embodiments, the 5G UE 1702 can correspond to the UE 110 of FIG. 1 and/or any other 5G UE described herein. In some embodiments, the source HgNB 1704 and the target HgNB 1706 can correspond to different HgNBs, such as the HgNB 118 of FIG. 1 and/or any other HgNB described herein. In some embodiments, the HgNB-GW 1708 can correspond to the gateway 102 of FIGS. 1, 2, 3, 4, and/or 5. In some embodiments, the AMF 1710 can correspond to the AMF 224 of FIG. 2 and/or any other AMF described herein. In some embodiments, the UPF 1712 can correspond to the UPF 518 and/or any other UPF described herein.

The workflow 1700 illustrates the Xn Direct Handover procedure between HgNBs using the HgNB-GW. For example, the workflow 1700 can be executed and/or performed to hand over a UE from a source HgNB to a target HgNB using the Xn interface when the AMF is not changed and the SMF decides to keep the existing UPF. In some embodiments, the workflow 1700 is not available between the small cell layer and the macro layer because there is no Xn routing allowed. The intra-HgNB handover can perform the preparation and execution phase of the handover procedure performed without involvement of the 5GC, directly exchanging preparation messages between HgNBs. If the serving PLMN changes during Xn-based handover, the source HgNB node can indicate to the target HgNB node (in the Mobility Restriction List) the selected PLMN ID to be used in the target network. If the AMF generates the N2 downlink signaling during the ongoing handover and receives a rejection to a N2 interface procedure (e.g., Location Reporting Control, DL NAS message transfer) from the HgNB with an indication that a Xn based handover procedure is in progress, the AMF may reattempt the same N2 interface procedure either when the handover is complete or the handover is deemed to have failed, when possible. The failure is known by expiry of the timer guarding the N2 interface procedure.

In some embodiments, upon reception for an SMF initiated N1 and/or N2 request(s) with an indication that the request has been temporarily rejected due to handover procedure in progress, the SMF can start a locally configured guard timer. Any network function (e.g., the SMF) can hold any signaling messages targeted towards AMF for a given UE during the handover preparation phase unless it detects that the handover execution is completed or handover has failed/cancelled. The network function (e.g., the SMF) may re-attempt, up to a pre-configured number of times, when either it detects that the handover is completed or has failed using message reception or at expiry of the guard timer.

Turning to the workflow 1700 of the illustrated examples of FIGS. 17A-17B, during a first operation, the Source HgNB sends to the UE a RRC Reconfiguration message to instruct the UE to measure a set of NR-ARFCNs where other neighbor cells can operate including the measConfig IE that contains the measObjectToaddModList IE with the measurement objects to apply in the UE. During a second operation. the UE responds to the Source HgNB sending a RRC Reconfiguration Complete message accepting the measurement configuration.

During a third operation, once the UE has measured a neighbor that meets the measurement criteria, the UE sends to the Source HgNB a RRC Measurement Report message including an ordered list of cells in the measResults IE. During a fourth operation, the RRM of the Source HgNB takes a Handover decision, and the Source HgNB sends to the Target HgNB a XnAP Handover Request message including Source NG RAN node UE XnAP ID reference, Target Cell Global ID, UE Context Information, GUAMI, UE History information IEs.

During a fifth operation, the Target HgNB performs Admission Control and responds to the Source HgNB sending a XnAP Handover Request Acknowledge message including Source NG RAN node UE XnAP ID, Target NG-RAN node UE XnAP ID, PDU Session Resources Admitted List and Target NG-RAN node to Source RAN node Transparent Container IEs.

During a sixth operation, the Source HgNB sends to the UE a RRC Reconfiguration message including the Handover Command message sent by the Target HgNB. During a seventh operation, the Source HgNB sends to the Target HgNB a XnAP SN Status Transfer message including Source NG RAN node UE XnAP ID, Target NG-RAN node UE XnAP ID and DRBs Subject to Status Transfer List IEs and from now, Downlink Data sent from the UPF to the Source HgNB is buffered in the Source HgNB to be forwarded to the Target HgNB until the UE camps on the Target HgNB.

During an eighth operation, the UE performs the Random-Access Procedure with the Target Cell of the Target HgNB. During a ninth operation, once the UE is connected, the UE sends the RRC Reconfiguration Complete to the Target HgNB. During a tenth operation, the Target HgNB sends to the HgNB-GW a Path Switch Request including the including RAN UE NGAP ID, Source AMF UE NGAP ID, User Location Information, and UE Security Capabilities and PDU Session Resource to be Switched in Downlink List IEs. During an eleventh operation, the HgNB-GW forwards to the AMF the previous Path Switch Request message to the AMF and now the UPF sends a N3 End Marker packet over GTPv2 to the Source HgNB that forwards it to the Target HgNB.

During a twelfth operation, the AMF sends to the HgNB-GW a Path Switch Request Acknowledge message including AMF UE NGAP ID, RAN UE NGAP ID, Security Context, PDU Session Resource Switched List and Allowed NSSAI IEs. During a thirteenth operation, the HgNB-GW forwards to the Target HgNB the Path Switch Request Acknowledge message but using the AMF UE NGAP ID known by the Target HgNB and adding the AMF UE NGAP ID 2 IE for HgNB mobility management purposes. During a fourteenth operation, the Target HgNB sends to the Source HgNB a XnAP UE Context Release message including the Source NG-RAN node UE XnAP ID and the Target NG-RAN node UE XnAP ID IEs and now the handover procedure is complete and then the UE can send and receive Uplink and Downlink Data to and from the Target HgNB and the UPF.

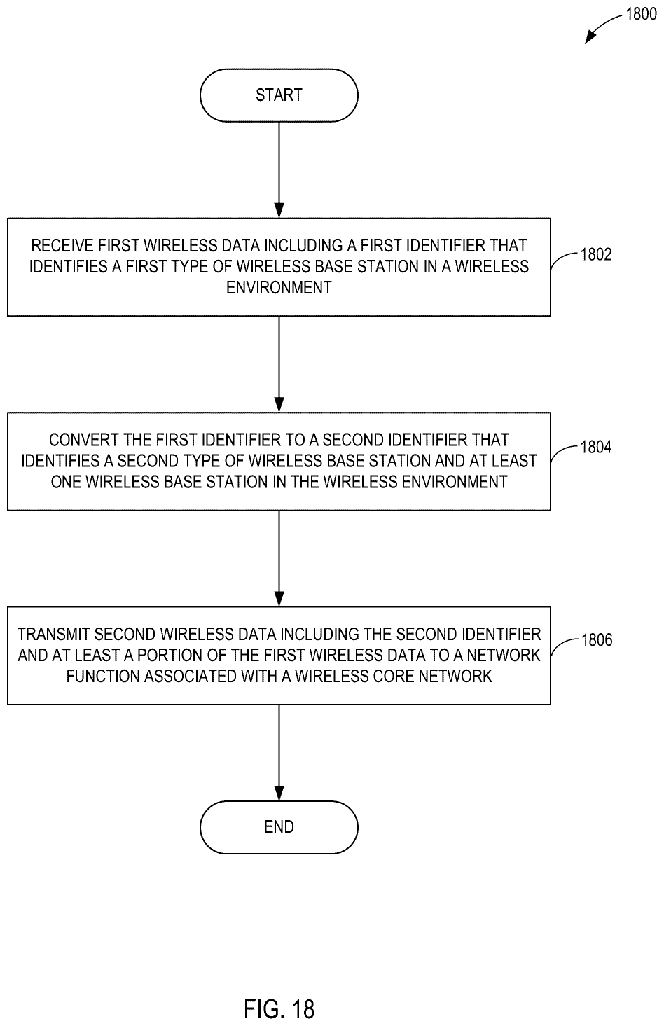

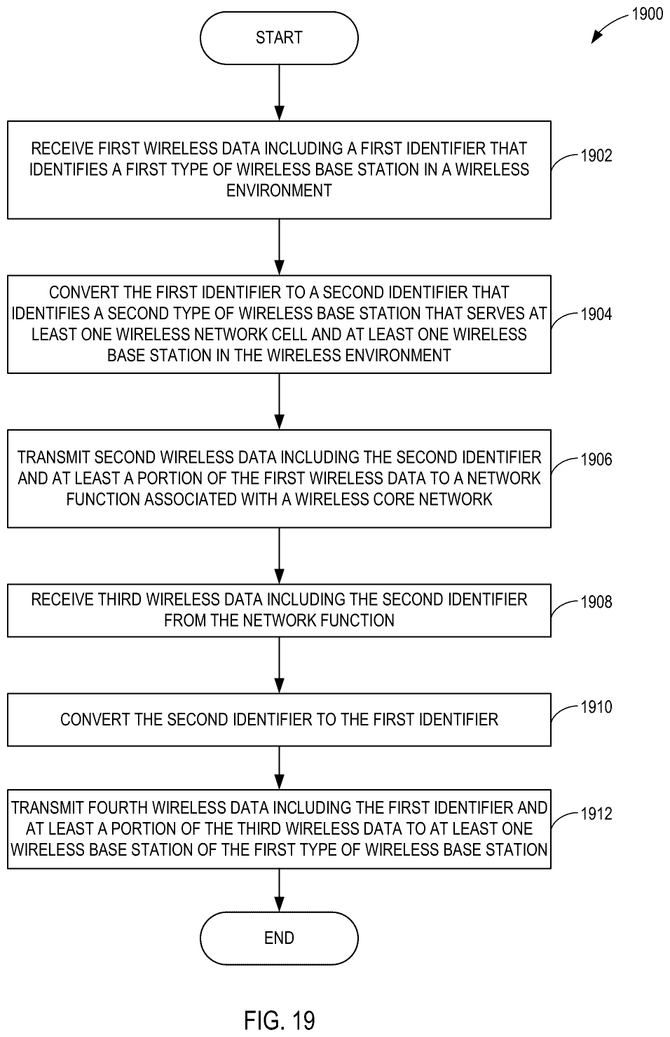

FIGS. 18-20 are flowcharts representative of example processes to be performed and/or example machine-readable instructions that may be executed by processor circuitry to implement an HgNB-GW, such as the gateway 102 of FIG. 1. Although a flowchart may be discussed in connection with one of the HgNB-GW described herein, the flowchart may also be applicable to any other one(s) of the HgNB-GW described herein. Additionally or alternatively, block(s) of one(s) of the flowcharts of FIGS. 18, 19, and/or 20 may be representative of state(s) of one or more hardware-implemented state machines, algorithm(s) that may be implemented by hardware alone such as an ASIC, etc., and/or any combination(s) thereof.

FIG. 18 is a flowchart 1800 representative of an example process that may be performed and/or implemented using hardware logic and/or example machine-readable instructions that may be executed by processor circuitry to implement an HgNB-GW, such as the gateway 102 of FIG. 1, to effectuate communication between a core network and at least one femtocell. The flowchart 1800 of FIG. 18 begins at block 1802, at which the gateway 102 of FIG. 1 can receive first wireless data including a first identifier that identifies a first type of wireless base station in a wireless environment. For example, the gateway 102 can receive, by the second interface 412, first wireless data such as first wireless control signaling data from the HgNB 118. In some embodiments, the first wireless control signaling data can include the HgNB ID 130, which can identify the first wireless control signaling data as originating from a first type of wireless base station, such as the HgNB 118. In some such embodiments, the HgNB 130 can identify that the first wireless control signaling data is to be transmitted to the first virtual node 402 (or a different virtual node such as the second virtual node 404) or if there is a need of creating an additional instance of a virtual node.

At block 1804, the gateway 102 can convert the first identifier to a second identifier that identifies a second type of wireless base station and at least one base station in the wireless environment. For example, the gateway 102 can convert the HgNB ID 130 into the gNB ID 128. In some embodiments, the gNB ID 128 can identify the first wireless control signaling data as originating from a second type of wireless base station, such as a gNB. In some such embodiments, the gNB ID 128 can identify a wireless base station of the second type, such as the first virtual node 402 or the second virtual node 404 of FIG. 4.

At block 1806, the gateway 102 can transmit second wireless data including the second identifier and at least a portion of the first wireless data to a network function associated with a wireless core network. For example, the gateway 102 can transmit, by the first interface 410, second wireless data, such as second wireless control signaling data, to a network function, such as the AMF 408 of FIG. 4 of a wireless core network, such as the core network 108 of FIG. 1. In some such embodiments, the second wireless control signaling data can include the gNB ID 128 and at least a portion of the first wireless data, such as payload data, UE requested data, etc. After transmitting the second wireless data at block 1806, the flowchart 1800 of FIG. 18 concludes. Alternatively, the flowchart 1800 of FIG. 18 may be re-executed.

FIG. 19 is a flowchart 1900 representative of an example process that may be performed and/or implemented using hardware logic and/or example machine-readable instructions that may be executed by processor circuitry to implement an HgNB-GW, such as the gateway 102 of FIG. 1, to effectuate communication between a core network and at least one femtocell. The flowchart 1900 of FIG. 19 begins at block 1902, at which the gateway 102 of FIG. 1 can receive first wireless data including a first identifier that identifies a first type of wireless base station in a wireless environment. For example, the gateway 102 can receive, by the second interface 412, first wireless control signaling data including the HgNB ID 130. In some such embodiments, the HgNB ID 130 can identify a first type of wireless base station, such as the HgNB 118, that serves at least one femtocell, such as the femtocell 106 of FIG. 1.

At block 1904, the gateway 102 can convert the first identifier to a second identifier that identifies a second type of wireless base station that serves at least one wireless network cell and at least one wireless base station in the wireless environment. For example, the gateway 102 can derive and/or generate the gNB ID 128 based on the HgNB ID 130. In some such embodiments, the gNB ID 128 can identify a second type of wireless base station, such as a gNB, and at least one wireless base station, such as at least the first virtual node 402 of FIG. 4. In some such embodiments, the gNB can be a type of base station that serves at least one 5G NR wireless cell.

At block 1906, the gateway 102 can transmit second wireless data including the second identifier and at least a portion of the first wireless data to a network function associated with a wireless core network. For example, the gateway 102 can transmit, by the first interface 410, second wireless data (e.g., UL data) including the gNB ID 128 and at least a portion of the first wireless data to the AMF 408 of a wireless core network, such as the core network 108 of FIG. 1.

At block 1908, the gateway 102 can receive third wireless data including the first identifier from the network function. For example, the gateway 102 can receive, by the first interface 410, third wireless data (e.g., DL data) including the gNB ID 128 from the AMF 408.

At block 1910, the gateway 102 can convert the second identifier to the first identifier. For example, the gateway 102 can convert and/or translate the gNB ID 128 into the HgNB ID 128.

At block 1912, the gateway 102 can transmit fourth wireless data including the first identifier and at least a portion of the third wireless data to at least one wireless base station of the first type of wireless base station. For example, the gateway 102 can transmit, by the second interface 412, fourth wireless data including the HgNB ID 130 and at least a portion of the third wireless data to the HgNB 118. After transmitting the fourth wireless data at block 1912, the flowchart 1900 of FIG. 19 concludes. Alternatively, the flowchart 1900 of FIG. 19 may be re-executed.

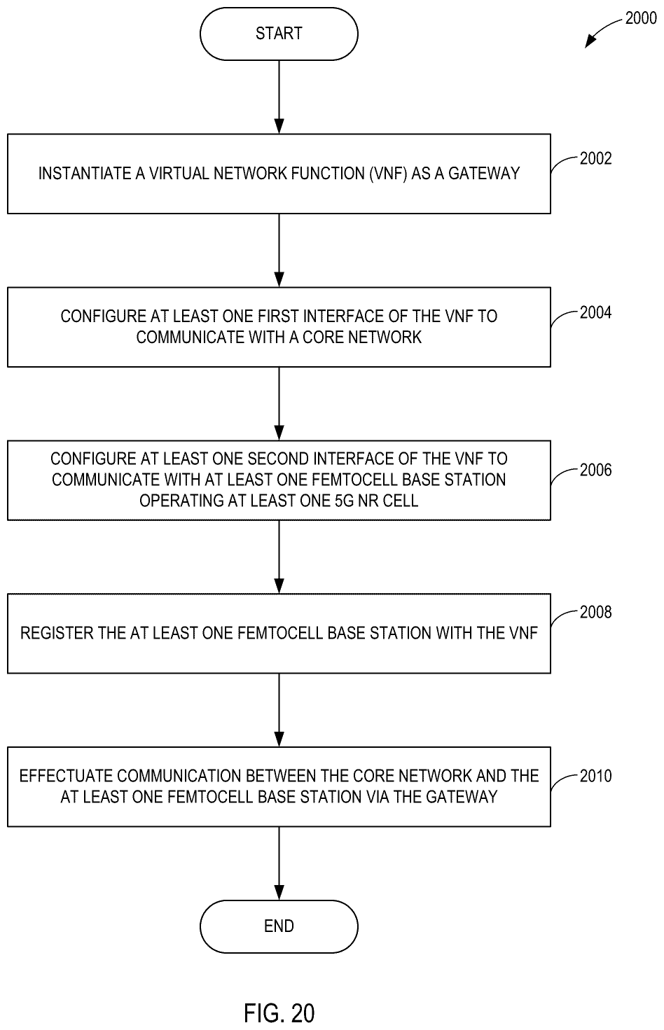

FIG. 20 is a flowchart 2000 representative of an example process that may be performed and/or implemented using hardware logic and/or example machine-readable instructions that may be executed by processor circuitry to implement a mobile network edge cloud, such as the mobile network edge cloud 104 of FIG. 1, to configure a virtualized network function as a gateway to effectuate communication between a core network and at least one femtocell base station. The flowchart 2000 of FIG. 20 begins at block 2002, at which the mobile network edge cloud 104 can instantiate a virtual network function (VNF) as a gateway. For example, the mobile network edge cloud 104 can instantiate the gateway 102 and/or the Xn-Proxy 220 as a gateway to effectuate communication between the multi-access core network cloud 208 and at least one femtocell base station, such as the HgNB 118 of FIG. 1.

At block 2004, the gateway 102 can configure at least one first interface of the VNF to communicate with a core network. For example, the gateway 102 can configure the first interface 410 to communicate with the AMF 408 of FIG. 4 and/or, more generally, the core network 108 of FIG. 1.

At block 2006, the gateway 102 can configure at least one second interface of the VNF to communicate with at least one femtocell base station operating at least one 5G NR cell. For example, the gateway 102 can configure the second interface 412 to communicate with one(s) of the first plurality of base stations 302 and/or one(s) of the second plurality of base stations 304, which are femtocell base stations, operating as and/or serving one or more 5G NR cells.

At block 2008, the gateway 102 can register the at least one femtocell base station with the VNF. For example, the gateway 102 can register the one(s) of the first plurality of base stations 302 and/or the one(s) of the second plurality of base stations 304 with the gateway 102 as described by any one(s) of the workflows 800, 810, 900, 1000, 1100, 1200, 1300, 1400, 1500, 1600, 1700 described herein.

At block 2010, the gateway 102 can effectuate communication between the core network and the at least one femtocell base station via the gateway. For example, the gateway 102 can receive uplink data from the one(s) of the first plurality of base stations 302 and/or one(s) of the second plurality of base stations 304 operating and/or serving one or more respective 5G NR cells. In some embodiments, the gateway 102 can receive downlink data from the core network 108 for delivery to the one(s) of the first plurality of base stations 302 and/or the one(s) of the second plurality of base stations 304 operating and/or serving one or more respective 5G NR cells. After effectuating communication between the core network and the at least one femtocell base station via the gateway at block 2010, the flowchart 2000 of FIG. 20 concludes. Alternatively, the flowchart 2000 of FIG. 20 may be re-executed.

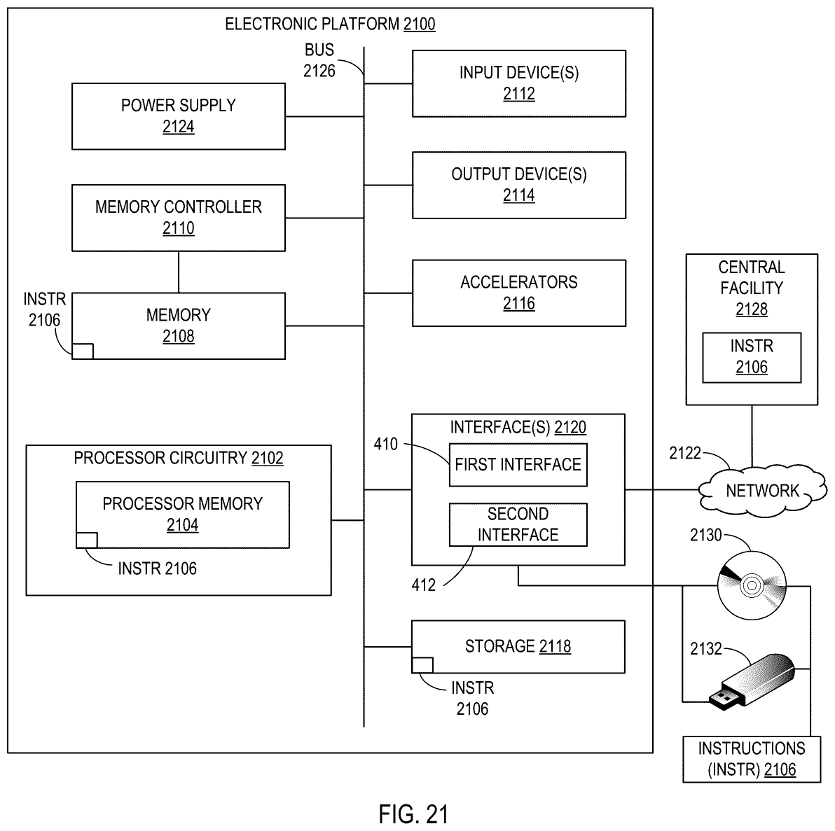

FIG. 21 is an example implementation of an electronic platform 2100 structured to execute portion(s) of the workflows 800, 810, 900, 1000, 1100, 1200, 1300, 1400, 1500, 1600, 1700 of FIGS. 8A, 8B, 8C, 9, 10, 11A, 11B, 12A, 12B, 13A, 13B, 14, 15A, 15B, 16A, 16B, 17A, and/or 17B and/or the machine-readable instructions of FIGS. 18, 19, and/or 20 to implement a gateway, such as the gateway 102 of FIGS. 1, 2, 3, 4, and/or 5. Alternatively, the electronic platform 2100 can implement a base station, such as a base station configured to implement the femtocell 106 of FIG. 1 and/or, more generally, the HgNB 118 of FIG. 1. It should be appreciated that FIG. 21 is intended neither to be a description of necessary components for an electronic and/or computing device to operate as a gateway or gateway circuitry, in accordance with the techniques described herein, nor a comprehensive depiction. The electronic platform 2100 of this example may be an electronic device, such as a handset device (e.g., a cellular network device, a smartphone, etc.), a desktop computer, a laptop computer, a tablet computer, a server (e.g., a computer server, a blade server, a rack-mounted server, a RAN server, etc.), a workstation, a base station (e.g., a 5G base station, a wireless base station), a distributed unit, a centralized unit, a core server, a remote radio unit, or any other type of computing and/or electronic device.

The electronic platform 2100 of the illustrated example includes processor circuitry 2102, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 2102 includes processor memory 2104, which may be volatile memory, such as random-access memory (RAM) of any type. The processor circuitry 2102 of this example can implement one or more programmable processors utilized to implement the gateway 102.

The processor circuitry 2102 may execute machine-readable instructions 2106 (identified by INSTRUCTIONS), which are stored in the processor memory 2104, to implement the gateway 102. The machine-readable instructions 2106 may include data representative of computer-executable and/or machine-executable instructions implementing techniques that operate according to the techniques described herein. For example, the machine-readable instructions 2106 may include data (e.g., code, embedded software (e.g., firmware), software, etc.) representative of portion(s) of the workflows 800, 810, 900, 1000, 1100, 1200, 1300, 1400, 1500, 1600, 1700 of FIGS. 8A, 8B, 8C, 9, 10, 11A, 11B, 12A, 12B, 13A, 13B, 14, 15A, 15B, 16A, 16B, 17A, and/or 17B and/or the flowcharts of FIGS. 18, 19, and/or 20, or portion(s) thereof.

The electronic platform 2100 includes memory 2108, which may include the instructions 2106. The memory 2108 of this example may be controlled by a memory controller 2110. For example, the memory controller 2110 may control reads, writes, and/or, more generally, access(es) to the memory 2108 by other component(s) of the electronic platform 2100. The memory 2108 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 2100 includes input device(s) 2112 to enable data and/or commands to be entered into the processor circuitry 2102. For example, the input device(s) 2112 may include an audio sensor, a camera (e.g., a still camera, a video camera, etc.), a keyboard, a microphone, a mouse, a touchscreen, a voice recognition system, etc., and/or any combination(s) thereof.

The electronic platform 2100 includes output device(s) 2114 to convey, display, and/or present information to a user (e.g., a human user, a machine user, etc.). For example, the output device(s) 2114 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 2114 can be used, among other things, to generate, launch, and/or present a user interface. For example, the user interface may be generated and/or implemented by the output device(s) 2114 for visual presentation of output and speakers or other sound generating devices for audible presentation of output.

The electronic platform 2100 includes accelerators 2116, which are hardware devices to which the processor circuitry 2102 may offload compute tasks to accelerate their processing. For example, the accelerators 2116 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some examples, one or more network functions implemented by the gateway 102 may be implemented by one(s) of the accelerators 2116 instead of the processor circuitry 2102. In some examples, a network function may be executed concurrently (e.g., in parallel, substantially in parallel, etc.) by the processor circuitry 2102 and the accelerators 2116. For example, the processor circuitry 2102 and one(s) of the accelerators 2116 may execute in parallel function(s) corresponding to the network function.

The electronic platform 2100 includes storage 2118 to record and/or control access to data, such as the machine-readable instructions 2106. The storage 2118 may be implemented by one or more mass storage disks or devices, such as HDDs, SSDs, etc., and/or any combination(s) thereof.

The electronic platform 2100 includes interface(s) 2120 to effectuate exchange of data with external devices (e.g., computing and/or electronic devices of any kind) via a network 2122. In this example, the interface(s) 2120 implements the first interface 410 and the second interface 412 of FIG. 4. The interface(s) 2120 of the illustrated example may be implemented by an interface device, such as network interface circuitry (e.g., a NIC, a smart NIC, etc.), a gateway, a router, a switch, etc., and/or any combination(s) thereof. The interface(s) 2120 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 2100 includes a power supply 2124 to store energy and provide power to components of the electronic platform 2100. The power supply 2124 may be implemented by a power converter, such as an alternating current-to-direct-current (AC/DC) power converter, a direct current-to-direct current (DC/DC) power converter, etc., and/or any combination(s) thereof. For example, the power supply 2124 may be powered by an external power source, such as an alternating current (AC) power source (e.g., an electrical grid), a direct current (DC) power source (e.g., a battery, a battery backup system, etc.), etc., and the power supply 2124 may convert the AC input or the DC input into a suitable voltage for use by the electronic platform 2100. In some examples, the power supply 2124 may be a limited duration power source, such as a battery (e.g., a rechargeable battery such as a lithium-ion battery).

Component(s) of the electronic platform 2100 may be in communication with one(s) of each other via a bus 2126. For example, the bus 2126 may be any type of computing and/or electrical bus, such as an I2C bus, a PCI bus, a PCIe bus, a SPI bus, and/or the like.

The network 2122 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 2122 may be the Internet, but any other type of private and/or public network is contemplated.

The network 2122 of the illustrated example facilitates communication between the interface(s) 2120 and a central facility 2128. The central facility 2128 in this example may be an entity associated with one or more servers, such as one or more physical hardware servers and/or virtualizations of the one or more physical hardware servers. For example, the central facility 2128 may be implemented by a public cloud provider, a private cloud provider, etc., and/or any combination(s) thereof. In this example, the central facility 2128 may compile, generate, update, etc., the machine-readable instructions 2106 and store the machine-readable instructions 2106 for access (e.g., download) via the network 2122. For example, the electronic platform 2100 may transmit a request, via the interface(s) 2120, to the central facility 2128 for the machine-readable instructions 2106 and receive the machine-readable instructions 2106 from the central facility 2128 via the network 2122 in response to the request.

Additionally or alternatively, the interface(s) 2120 may receive the machine-readable instructions 2106 via non-transitory machine-readable storage media, such as an optical disc 2130 (e.g., a Blu-ray disc, a CD, a DVD, etc.) or any other type of removable non-transitory machine-readable storage media such as a USB drive 2132. For example, the optical disc 2130 and/or the USB drive 2132 may store the machine-readable instructions 2106 thereon and provide the machine-readable instructions 2106 to the electronic platform 2100 via the interface(s) 2120.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions implementing the techniques described herein (when implemented as one or more functional facilities or in any other manner) may, in some embodiments, be encoded on one or more computer-readable media, machine-readable media, etc., to provide functionality to the media. Computer-readable media include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium may be implemented in any suitable manner. As used herein, the terms “computer-readable media” (also called “computer-readable storage media”) and “machine-readable media” (also called “machine-readable storage media”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques-such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

Various aspects are described in this disclosure, which include, but are not limited to, the following aspects:
1. A method for providing wireless communication coverage in a wireless environment, comprising: receiving, by a first interface of a virtualized network function, first wireless data comprising a first identifier that identifies a first type of wireless base station in the wireless environment; converting, by the virtualized network function, the first identifier to a second identifier, the second identifier identifying a second type of wireless base station and at least one wireless base station of a plurality of wireless base stations in the wireless environment, the second type of wireless base station being different from the first type of wireless base station, the at least one wireless base station being a virtual wireless base station instantiated by the virtualized network function and configured to execute a set of functions to effectuate wireless communication in the wireless environment; and transmitting, by a second interface of the virtualized network function, second wireless data to a network function associated with a wireless core network, the second wireless data comprising the second identifier and at least a portion of the first wireless data.
2. The method of aspect 1, wherein the first identifier is a New Radio Cell Global Identity (NCGI) comprising a concatenation of a Public Land Mobile Network (PLMN) identity and a New Radio Cell Identity (NCI).
3. The method of aspect 2, wherein the PLMN identity comprises a mobile country code identifying a country and a mobile network code identifying a mobile network operator in the country.
4. The method of aspect 2, wherein the NCI comprises at least one of a Home Next Generation Node B (HgNB) identity or a cell identity, the HgNB identity identifying a femtocell base station, and the cell identity identifying a wireless cell operated by the femtocell base station.
5. The method of aspect 1, wherein the first identifier comprises a Home Next Generation Node B (HgNB) identity having a first number of bits and the second identifier comprises a Next Generation Node B (gNB) identity having a second number of bits different from the first number of bits.
6. The method of aspect 1, further comprising: receiving, by the second interface of the virtualized network function, third wireless data from the network function, the third wireless data comprising the second identifier; converting, by the virtualized network function, the second identifier to the first identifier; and transmitting, by the first interface of the virtualized network function, fourth wireless data to a femtocell base station, the fourth wireless data comprising the first identifier and at least a portion of the third wireless data.
7. The method of aspect 1, wherein the wireless core network is a fifth generation cellular core network, and instantiating the virtualized network function further comprises: configuring the first interface to aggregate control signaling from a plurality of femtocell base stations to the wireless core network; and configuring the second interface to communicate with one or more virtualized network functions hosted by the fifth generation cellular core network, the one or more virtualized network functions comprising the network function.
8. The method of aspect 1, wherein receiving the third wireless data comprises receiving the third wireless data from an access and mobility management function hosted by the wireless core network.
9. The method of aspect 1, further comprising instantiating a plurality of additional virtual wireless base stations hosted by the virtualized network function.
10. The method of aspect 1, further comprising: generating the virtual wireless base station in the wireless environment, wherein the virtual wireless base station is configured to effectuate communication between the wireless core network and the plurality of base stations, the virtual wireless base station being configured to be represented as a single wireless base station to the wireless core network, and the virtual wireless base station being configured to be represented as one or more virtualized network functions hosted by the wireless core network to the plurality of base stations.
11. The method of aspect 10, wherein each of the plurality of base stations are operating one or more femtocells, and generating the virtual wireless base station comprises configuring the virtual wireless base station to be represented to the wireless core network as a wireless base station operating one or more macrocells.
12. The method of aspect 10, wherein the virtual wireless base station has the second identifier, and the second identifier comprises a first number of bits different from a second number of bits of the first identifier.
13. The method of aspect 10, wherein the virtual wireless base station is a Next Generation Node B (gNB), the one or more virtualized network functions comprise at least one of an access and mobility management function or a session management function, and generating the virtual wireless base station comprises configuring the virtual wireless base station to be represented (i) to the wireless core network as the gNB and (ii) to the plurality of base stations as at least one of the access and mobility management function or the session management function hosted by the wireless core network.
14. The method of aspect 1, wherein the first type of wireless base station is a femtocell base station.
15. The method of aspect 1, wherein the second type of wireless base station is a macrocell base station.
16. The method of aspect 1, wherein the wireless environment is a fifth generation cellular (5G) environment, the first identifier identifies a 5G femtocell and the second identifier identifies a 5G gNB.
17. The method of aspect 1, wherein the first type of wireless base station is a femtocell base station, and the first identifier is associated with a single-cell configuration comprising a single femtocell or a multi-cell configuration comprising two or more femtocells.
18. An apparatus comprising a memory storing instructions, and a processor configured to execute the instructions to perform the method of any one of aspects 1-17.
19. At least one computer-readable storage medium comprising instructions that, when executed, cause a processor to perform the method of any one of aspects 1-17.
20. A system comprising a core cloud, at least one user equipment, and an edge cloud server, the edge cloud server comprising a memory storing instructions, and a processor configured to execute the instructions to perform the method of any one of aspects 1-17.
21. A low power fifth generation base station, wherein the base station is a femtocell or Home Next Generation Node B (HgNB), the base station comprising: a set of wireless radio units, each wireless radio unit comprising at least one antenna for wirelessly communicating with user equipment; a communication interface for communicating with a virtualized network interface of a fifth generation cellular network; and a processor in communication with the set of wireless radio units and the communication interface, wherein the processor is configured to use the communication interface to communicate wireless data between the user equipment and the virtualized network interface of the fifth generation cellular network.
22. An apparatus for providing wireless communication coverage in a wireless environment, the apparatus comprising: at least one memory; machine-readable instructions; and processor circuitry to execute the machine-readable instructions to at least: receive, by a first interface of a virtualized network function, first wireless data comprising a first identifier that identifies a first type of wireless base station in the wireless environment; convert, by the virtualized network function, the first identifier to a second identifier, the second identifier identifying a second type of wireless base station and at least one wireless base station of a plurality of wireless base stations in the wireless environment, the second type of wireless base station being different from the first type of wireless base station, the at least one wireless base station being a virtual wireless base station instantiated by the virtualized network function and configured to execute a set of functions to effectuate wireless communication in the wireless environment; and transmit, by a second interface of the virtualized network function, second wireless data to a network function associated with a wireless core network, the second wireless data comprising the second identifier and at least a portion of the first wireless data.
23. The apparatus of aspect 22, wherein the first identifier comprises a Home Next Generation Node B (HgNB) identity having a first number of bits and the second identifier comprises a Next Generation Node B (gNB) identity having a second number of bits different from the first number of bits.
24. At least one non-transitory computer-readable storage medium comprising instructions that, when executed, cause a processor to at least: receive, by a first interface of a virtualized network function, first wireless data comprising a first identifier that identifies a first type of wireless base station in the wireless environment; convert, by the virtualized network function, the first identifier to a second identifier, the second identifier identifying a second type of wireless base station and at least one wireless base station of a plurality of wireless base stations in the wireless environment, the second type of wireless base station being different from the first type of wireless base station, the at least one wireless base station being a virtual wireless base station instantiated by the virtualized network function and configured to execute a set of functions to effectuate wireless communication in the wireless environment; and transmit, by a second interface of the virtualized network function, second wireless data to a network function associated with a wireless core network, the second wireless data comprising the second identifier and at least a portion of the first wireless data.

What is claimed is:

1. A method for providing wireless communication coverage in a wireless environment, comprising:
receiving, by a first interface of a virtualized network function, first wireless data comprising a first identifier that identifies a first type of wireless base station in the wireless environment;
converting, by the virtualized network function, the first identifier to a second identifier, the second identifier identifying a second type of wireless base station and at least one wireless base station of a plurality of wireless base stations in the wireless environment, the second type of wireless base station being different from the first type of wireless base station, the at least one wireless base station being a virtual wireless base station instantiated by the virtualized network function and configured to execute a set of functions to effectuate wireless communication in the wireless environment; and
transmitting, by a second interface of the virtualized network function, second wireless data to a network function associated with a wireless core network, the second wireless data comprising the second identifier and at least a portion of the first wireless data.

2. The method of claim 1, wherein the first identifier is a New Radio Cell Global Identity (NCGI) comprising a concatenation of a Public Land Mobile Network (PLMN) identity and a New Radio Cell Identity (NCI).

3. The method of claim 2, wherein the PLMN identity comprises a mobile country code identifying a country and a mobile network code identifying a mobile network operator in the country.

4. The method of claim 2, wherein the NCI comprises at least one of a Home Next Generation Node B (HgNB) identity or a cell identity, the HgNB identity identifying a femtocell base station, and the cell identity identifying a wireless cell operated by the femtocell base station.

5. The method of claim 1, wherein the first identifier comprises a Home Next Generation Node B (HgNB) identity having a first number of bits and the second identifier comprises a Next Generation Node B (gNB) identity having a second number of bits different from the first number of bits.

6. The method of claim 1, further comprising:
receiving, by the second interface of the virtualized network function, third wireless data from the network function, the third wireless data comprising the second identifier;
converting, by the virtualized network function, the second identifier to the first identifier; and
transmitting, by the first interface of the virtualized network function, fourth wireless data to a femtocell base station, the fourth wireless data comprising the first identifier and at least a portion of the third wireless data.

7. The method of claim 1, wherein the wireless core network is a fifth generation cellular core network, and instantiating the virtualized network function further comprises:
configuring the first interface to aggregate control signaling from a plurality of femtocell base stations to the wireless core network; and
configuring the second interface to communicate with one or more virtualized network functions hosted by the fifth generation cellular core network, the one or more virtualized network functions comprising the network function.

8. The method of claim 1, wherein receiving the third wireless data comprises receiving the third wireless data from an access and mobility management function hosted by the wireless core network.

9. The method of claim 1, further comprising instantiating a plurality of additional virtual wireless base stations hosted by the virtualized network function.

10. The method of claim 1, further comprising:
generating the virtual wireless base station in the wireless environment, wherein the virtual wireless base station is configured to effectuate communication between the wireless core network and the plurality of base stations, the virtual wireless base station being configured to be represented as a single wireless base station to the wireless core network, and the virtual wireless base station being configured to be represented as one or more virtualized network functions hosted by the wireless core network to the plurality of base stations.

11. The method of claim 10, wherein each of the plurality of base stations are operating one or more femtocells, and generating the virtual wireless base station comprises configuring the virtual wireless base station to be represented to the wireless core network as a wireless base station operating one or more macrocells.

12. The method of claim 10, wherein the virtual wireless base station has the second identifier, and the second identifier comprises a first number of bits different from a second number of bits of the first identifier.

13. The method of claim 10, wherein the virtual wireless base station is a Next Generation Node B (gNB), the one or more virtualized network functions comprise at least one of an access and mobility management function or a session management function, and generating the virtual wireless base station comprises configuring the virtual wireless base station to be represented (i) to the wireless core network as the gNB and (ii) to the plurality of base stations as at least one of the access and mobility management function or the session management function hosted by the wireless core network.

14. The method of claim 1, wherein the first type of wireless base station is a femtocell base station.

15. The method of claim 1, wherein the second type of wireless base station is a macrocell base station.

16. The method of claim 1, wherein the wireless environment is a fifth generation cellular (5G) environment, the first identifier identifies a 5G femtocell and the second identifier identifies a 5G gNB.

17. The method of claim 1, wherein the first type of wireless base station is a femtocell base station, and the first identifier is associated with a single-cell configuration comprising a single femtocell or a multi-cell configuration comprising two or more femtocells.

18. An apparatus for providing wireless communication coverage in a wireless environment, the apparatus comprising:
at least one memory;
machine-readable instructions; and
processor circuitry to execute the machine-readable instructions to at least:
receive, by a first interface of a virtualized network function, first wireless data comprising a first identifier that identifies a first type of wireless base station in the wireless environment;
convert, by the virtualized network function, the first identifier to a second identifier, the second identifier identifying a second type of wireless base station and at least one wireless base station of a plurality of wireless base stations in the wireless environment, the second type of wireless base station being different from the first type of wireless base station, the at least one wireless base station being a virtual wireless base station instantiated by the virtualized network function and configured to execute a set of functions to effectuate wireless communication in the wireless environment; and
transmit, by a second interface of the virtualized network function, second wireless data to a network function associated with a wireless core network, the second wireless data comprising the second identifier and at least a portion of the first wireless data.

19. The apparatus of claim 18, wherein the first identifier comprises a Home Next Generation Node B (HgNB) identity having a first number of bits and the second identifier comprises a Next Generation Node B (gNB) identity having a second number of bits different from the first number of bits.

20. At least one non-transitory computer-readable storage medium comprising instructions that, when executed, cause a processor to at least:
receive, by a first interface of a virtualized network function, first wireless data comprising a first identifier that identifies a first type of wireless base station in the wireless environment;
convert, by the virtualized network function, the first identifier to a second identifier, the second identifier identifying a second type of wireless base station and at least one wireless base station of a plurality of wireless base stations in the wireless environment, the second type of wireless base station being different from the first type of wireless base station, the at least one wireless base station being a virtual wireless base station instantiated by the virtualized network function and configured to execute a set of functions to effectuate wireless communication in the wireless environment; and
transmit, by a second interface of the virtualized network function, second wireless data to a network function associated with a wireless core network, the second wireless data comprising the second identifier and at least a portion of the first wireless data.
